(19) United States
(12) Patent Application Publication
(10) Pub. No.: US 2002/0015162 A1
(43) Pub. Date: Feb. 7, 2002

(54) Medium whereon image data interpolation program has been recorded, image data interpolation method, and image data interpolation apparatus

(75) Inventors: Jun Hoshii, Suwa-shi (JP); Yoshihiro Nakami, Suwa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SEIKO EPSON CORPORATION, Tokyo (JP)

(21) Appl. No.: 09/840,075

(22) Filed: Apr. 24, 2001

(30) Foreign Application Priority Data
Apr. 24, 2000 (JP) 2000-123174
Apr. 24, 2000 (JP) 2000-123175

(51) Int. Cl. G06K 15/02; G06T 3/40

(52) U.S. Cl. 358/1.2; 382/300

(57) ABSTRACT

Generally, it is not easy to judge automatically and correctly whether the attribute of an image is the one belonging to logos and illustrations or the one belonging to natural pictures. Due to incorrect judgment, sometimes, unsuitable interpolation execution has occurred.

Pixels interpolated by the first interpolation processing and pixels interpolated by the second interpolation processing are blended, based on a predetermined evaluation function, and placed on a source image. Because the evaluation function depends on the attribute of the image, a blending ratio between the pixels interpolated separately in two modes of interpolation can be determined, according to the image attribute, with high percentages assigned to more suitable interpolation processing. The merit of each mode of interpolation processing becomes more noticeable, whereas the demerit of each becomes mild. Consequently, the invention can prevent an error in selecting an interpolation method, based on the appraised attribute of the image for which interpolation is executed.

### BACKGROUND OF THE INVENTION

1. Field of the Invention

The present invention relates to a medium whereon an image data interpolation program has been recorded, an image data interpolation method, and an image data interpolation apparatus.

2. Description of Related Art

When an image is processed by a computer, it is represented in dot matrix pixels, with each pixel having a tone value. On the screen of a computer, for example, a photograph or a computer graphics image is often represented in 640 dots of pixels in the horizontal direction and 480 dots of pixels in the vertical direction.

Meanwhile, the performance of color printers has been enhanced remarkably with very dense dots such as 720 dpi (dots per inch), achieving high precision printing. When such printer prints an image represented in pixels of 640 dots by 480 dots with dot-to-dot correspondence, the printed corresponding image would be very small. In this case, because the image data generated on the computer and the printed image differ in the tone values and what is meant by resolution, pixels should be interpolated between the dots generated on the computer, thereby converting the image to printing image data. Specifically, if the printer prints a smaller image from the image data with dot-to-dot correspondence, multiplying the pixels of the image should be performed (this is referred to as conversion to higher resolution or image enlargement). Inversely, if the printer prints a larger image, reducing the pixels of the image should be performed (this is referred to as conversion to lower resolution or image reduction).

As conventional methods of interpolation of dots in such cases, the following are known: nearest neighbor interpolation (hereinafter referred to as a nearest method), cubic convolution interpolation (hereinafter referred to as a cubic method), and a pattern matching method. These interpolation methods have their specific feature. For example, the cubic method enables image interpolation without affecting the tone gradation of a source image, though the amount of arithmetic processing is large. Thus, this method is generally suitable for image interpolation of a natural picture consisting of multi-tone pixels. The pattern matching method enables interpolation by which the contours in an image are sharpened, though tending to affect the tone gradation of a source image. Thus, this method is generally suitable for image interpolation of logos and illustrations with a small number of tones.

To apply interpolation to image data, based on which a printer prints a good image, conventionally, the pattern matching method is used if the image to which interpolation is to be applied is regarded as the one belonging to logos and illustrations, and the cubic method is used if such image is regarded as the one belonging to natural pictures. However, it is generally not easy to judge automatically and correctly whether the attribute of an image is the one belonging to logos and illustrations or the one belonging to natural pictures. Due to incorrect judgment, sometimes, unsuitable interpolation execution has occurred. Discrimination between natural pictures and logos or illustrations is not absolute and objects that sharpening the contour is desirable may exist in a natural picture image.

Even if interpolation processing suitable for the attribute of an image is performed, it is useless to apply interpolation for natural pictures by which subtle tune gradation is reproduced to an image to be printed by low quality setting.

### SUMMARY OF THE INVENTION

An object of the present invention, produced by our study efforts to solve the above problem, is to provide a medium whereon an image data interpolation program has been recorded, an image data interpolation method, and an image data interpolation apparatus that prevent incorrect selection of an interpolation method, based on the appraised attribute of the image for which interpolation is executed, and enable proper interpolation processing suitable for print quality.

As a constitution of the present invention, contrived to attain the above object, one aspect of the invention is a medium whereon an image data interpolation program has been recorded to implement pixel interpolation to image data of an image represented in multi-tone dot matrix pixels on a computer. The medium with the above program recorded thereon, after being set ready for use on a computer, makes the computer perform: a function of image data acquisition that acquires image data; a first interpolation processing function that interpolates pixels to the image data without decreasing the degree of tone value difference between the existing pixels; a second interpolation processing function that interpolates pixels to the image data without affecting the gradation of the tones of the image; a first function of determining a blending ratio that appraises the attribute of the image, based on reference pixels around a pixel of target of interpolation and determines a blending ratio between pixel interpolations generated by the first interpolation processing and those generated by the second interpolation processing, based on the appraised attribute; a function of image data blending that blends the image data of interpolations generated by the first interpolation processing function and the corresponding data generated by the second interpolation processing function at the determined blending ratio; and an image data output function that outputs the thus blended data as interpolation-processed image data.

In the invention constituted as above, an initial step for making a computer perform pixel interpolation to image data represented in multi-tone dot matrix pixels is that image data is acquired by the image data acquisition function. Interpolation processing to the acquired image data can be executed by the first interpolation processing function and the second interpolation processing function. The first interpolation processing function interpolates pixels to the image data without decreasing the degree of tone value difference between the existing pixels. The second interpolation processing function interpolates pixels to the image data without affecting the gradation of the tones of the image.

The first function of determining a blending ratio appraises the attribute of the image, based on reference pixels around a pixel of target of interpolation and determines a blending ratio between pixel interpolations generated by the first interpolation processing and those generated by the second interpolation processing, based on the appraised attribute. The function of image data blending blends the image data of interpolations generated by the first interpolation processing function and the corresponding data generated by the second interpolation processing function at the blending ratio determined by the first function of determining a blending ratio. Then, the image data output function outputs the thus blended data as interpolation-processed image data. Thus, the present invention enables two modes of interpolation processing by means of the first interpolation processing function and the second interpolation processing function. The pixels of image data interpolated by both functions are blended at a ratio that reflects the attribute of the image. Thus, there is no possibility that incorrect judgment is made as to whether logos or natural pictures to which the image for which interpolation is executed belongs, causing the execution of only interpolation processing that is unsuitable for the interpolation of that image; i.e., a decisive error in selecting an interpolation method is eliminated.

The above first function of determining a blending ratio, however, not only sets a ratio between pixels generated by the first interpolation processing and those generated by the second interpolation processing that are mixed when being interpolated, but also can set a value of “0” or “1” which represents 0:100% or 100%:0 naturally.

By applying the present invention as explained above, the pixels interpolated separately in two modes of interpolation processing are blended, based on an evaluation function that depends on reference pixel data, and therefore, it is feasible to prevent an error in selecting an interpolation method, based on the appraised attribute of the image for which interpolation is executed.

Hereupon, the first interpolation processing function, defined as the ability to execute interpolation processing without decreasing the degree of tone value difference between the existing pixels, corresponds to an interpolation process wherein what is called an edge can be kept intact or highlighted without being shaded. The second interpolation processing function, defined as the ability to execute interpolation processing without affecting the gradation of tones of the image, corresponds to an interpolation process wherein subtle gradation of tone values can be reproduced with the tone values that subtly differ among the pixels not being made uniform. When the first function of determining a blending ratio refers to a plurality of pixels around a pixel of target of interpolation, it can find how the tone values of the reference pixels are distributed in a range, based on which it appraises the attribute of the image, such as “like a natural picture” or “like an illustration.” Thus, it can be said that the reference pixel data reflects the attribute of the image for which interpolation is executed. According to the attribute of the image for which interpolation is executed, a higher percentage of either the above first interpolation processing or second interpolation processing which is suitable for that image can be set when a blending ratio is determined.

There are types of interpolation processing methods as mentioned above. Even if the above two modes of interpolation processing are executed, it is not necessary to restrict the application range to two types of interpolation processing to generate pixels to be blended. As an example of constitution in view hereof, the invention can be constituted in another aspect such that the above first interpolation processing function and second interpolation processing function can select interpolation processing to be executed out of a plurality of types of interpolation processing. That is, there are a plurality of types of interpolation to be executed by the first interpolation processing function to avoid decreasing the degree of tone value difference between the existing pixels. Similarly, there are a plurality of types of interpolation to be executed by the second interpolation processing function to avoid affecting the gradation of the tones of the image. From among them, by selecting an interpolation type suitable for the image for which interpolation is executed or selecting the one that can be used, interpolation processing that is more suitable for the category of the image can be performed.

By applying the present invention in this way, the range of interpolation processing options is extended and interpolation that is more proper processing can be performed.

As a concrete example of this constitution, the invention can be constituted in another aspect such that the above first interpolation processing function is able to execute pattern matching interpolation which is performed, according to a predetermined rule, when a given pattern exists in the reference pixels, and interpolation by the nearest method. Because a given pattern is often detected, based on the degree of tone value difference between the existing pixels, pattern matching interpolation is applied in such cases. For a pattern that may be detected, an interpolation rule is predetermined so that interpolation will be executed to retain or highlight the tone value difference. In this way, image interpolation can be executed without decreasing the degree of tone value difference.

On the other hand, because the nearest method gives a pixel to be interpolated the value of a source image pixel or pixels nearest to it, the degree of tone value difference is retained. Thus, both the pattern matching and nearest method belongs to the mode of the first interpolation processing function and either can be selected, according to circumstances. In fact, if a given pattern does not exist in the reference pixels, the above pattern matching interpolation cannot be executed; in this case, the nearest method will be selected and executed.

By applying the present invention in this way, interpolation can easily be performed without decreasing the degree of tone value difference between the existing pixels.

Furthermore, as a concrete example of the second interpolation processing function, the invention is constituted in another aspect such that the above second interpolation processing function is enable to execute interpolation by the cubic method. In the interpolation by the cubic method, generally, 16 pixels around a pixel of target of interpolation are used as reference pixels and the method generates data of pixels of interpolations in which the tone values of the reference pixels are reflected, according to the degree of influence of the reference pixels on the target pixel depending on their distance to that pixel. By the cubic method, thus, subtle tone graduation of the reference pixels can be reflected to the pixels of interpolations. The cubic method belongs to the mode of the second interpolation processing function. By blending the pixels interpolated by the cubic method with those interpolated by the first mode of interpolation, interpolation suitable for a multi-tone natural image can be supported.

By applying the present invention in this way, interpolation can easily be performed without affecting the gradation of the tones of the image.

As the one essential to blending pixels interpolated separately in two modes of interpolation processing to the image for which interpolation is executed, the above first function of determining a blending ratio between both modes. The way of determining thereof is varied. As an example of constitution in view hereof, the invention may be constituted in another aspect such that the above first function of determining a blending ratio determines a blending ratio by using an evaluation function that depends on the above reference pixels data. This evaluation function is a function dependent on the reference pixels data and the reference pixels reflect the attribute of the image for which interpolation is executed as described above. Thus, by using the evaluation function dependent on the reference pixels data, a blending ratio between the pixels interpolated by the first interpolation processing and the pixels interpolated by the second interpolation processing can easily be determined.

By applying the present invention in this way, a blending ratio can easily be calculated.

As an example of concrete method of determining a blending ratio, the invention may be constituted such that the above first function of determining a blending ratio determines a blending ratio, based on the tone values of the above reference pixels. The tone values of the reference pixels reflect the attribute of the image for which interpolation is executed and by using a function dependent on the tone values, a blending ratio can be determined, according to the attribute of the image for which interpolation is executed.

By applying the present invention in this way, a blending ratio can easily be determined, according to the attribute of the image for which interpolation is executed.

Furthermore, as an example of this constitution, the invention may be constituted in another aspect such that the above first function of determining a blending ratio determines a blending ratio, based on the number of discrete tone values appearing in the above reference pixels. Because a logo or illustration image is normally depicted in a small number of colors, some of the reference pixels are considered having a common tone value and only a small number of pixels have their discrete tone value. By contrast, because a natural picture is normally depicted in a great number of colors, most of the reference pixels have their discrete tone value. In this way, the number of discrete tone values appearing in the reference pixels reflects the attribute of the image for which interpolation is executed and a blending ratio can be determined, according to the attribute of the image. As a concrete example of such reflection, after counting the number of discrete tone values appearing in the reference pixels, the smaller this count, the higher percentage of the above first interpolation processing will be set when a blending ratio is determined.

By applying the present invention in this way, a blending ratio can be determined, depending on whether the image is like a natural picture or a non-natural picture.

Furthermore, as an example of such constitution, the invention may be constituted in another aspect such that the above first function of determining a blend ratio gives a blending ratio on the condition that when the above number of discrete tone values appearing in the reference pixels is less than a predetermined threshold, only the above first interpolation processing should be used. As described above, the greater the number of discrete tone values appearing, the image becomes colorful; inversely, the smaller the number of discrete tone values appearing, the image becomes monotonous. If the number of discrete tone values appearing in the reference pixel is less than a predetermined threshold, the image is regarded as belonging to illustrations and logos and the first function of determining a blending ratio gives a blending ratio so that only the above first interpolation processing will be active. Consequently, this can prevent: blending of pixels interpolated by the above cubic method or the like and the pixels of an illustration or logo image; increase of arithmetic processing time in vain; and shading the contours.

By applying the present invention in this way, a blending ratio can be determined, depending on whether the image is like a natural picture or a non-natural picture.

Furthermore, as an example of another constitution, the invention may be constituted in another aspect such that the above first function of determining a blending ratio increases the percentage of the above first interpolation processing in direct proportion to the increase of the width of the range within which the tone values of the above reference pixels fall when determining a blending ratio. Hereupon, the width of the range of the tone values is difference between the maximum tone value and the minimum tone value. When what is called an edge is formed in the reference pixels, this width of the range of the tone values becomes larger. Then, the larger the width of the range of the tone values, the greater percentage of the above first interpolation processing will be set when a blending ratio is determined. In this way, when more edge-like visualization exists in the reference pixels, image interpolation is executed not to decrease the edge. Specifically, this can be realized by using the value of the above evaluation function that monotonously increases in direct proportion to the increase of the width of the tone value range. Based on this value, the percentage of the first interpolation processing is set when a blending ratio is determined.

By applying the present invention in this way, when more edge-like visualization exists in the reference pixels, image interpolation can be performed not to decrease the edge.

Furthermore, as a concrete example of the above tone values, the invention may be constituted in another aspect such that the above tone values of the reference pixels are luminance values. When an image is represented in multi-tone dot matrix pixels, normally, a pixel has tone value data for each color and a value of luminance of the pixel is determined from the tone value data for each color. Thus, the characteristics of a pixel can be grasped exactly by using its luminance value and can be reflected in calculating a blending ratio.

By applying the present invention in this way, the characteristics of a pixel can be reflected exactly in the evaluation function.

Then, such image interpolation program can be applied as part of a print control program that makes a computer perform interpolation processing as well as print control processing, in order to obtain image data input and send interpolation-processed image data to a printer where a print is obtained from such image data.

For this purpose, the present invention may be constituted in another aspect to make the computer, in addition to the above functions, perform: a function of print quality parameters acquisition that acquires print quality parameters, according to which the above printer prints an image from the above image data; a second function of determining a blending ratio that determines a blending ratio between the pixels interpolated by the first interpolation processing and those interpolated by the second interpolation processing, based on the print quality parameters; and a function of print control processing that executes print control processing, based on the data of pixel interpolations blended at the above blending ratio.

In the invention constituted as above, an initial step for making a computer perform interpolation processing as well as print control processing in order to obtain the input of image data of an image represented in multi-tone dot matrix pixels and send interpolation-processed image data to the printer where a print is obtained from the image data is that the print quality parameters acquisition function acquires print quality parameters, according to which the above printer prints an image from the above image data. The second function of determining a blending ratio determines a blending ratio between pixel interpolations generated by the first interpolation processing and those generated by the second interpolation processing, based on the print quality parameters acquired. The function of image data blending blends the image data of interpolations generated by the first interpolation processing function and the corresponding data generated by the second interpolation processing function at the blending ratio determined by the second function of determining a blending ratio. Then, the function of print control processing executes print control processing, based on the thus blended data. Thus, the present invention enables two modes of interpolation processing by means of the first interpolation processing function and the second interpolation processing function. The pixels of image data interpolated by both functions are blended at a ratio that is determined, based on the print quality setting. In consequence, print results can be obtained from the data processed by interpolation that is effective for each parameter setting of print quality. Moreover, there is no possibility that incorrect judgment is made as to whether logos or natural pictures to which the image for which interpolation is executed belongs, causing the execution of only interpolation processing that is unsuitable for the interpolation of that image; i.e., there is no possibility that the printer makes poor print results due to a decisive error in selecting an interpolation method.

Reasonably, also in this embodiment mode, the second function of determining a blending ratio not only sets a ratio between pixels generated by the first interpolation processing and those generated by the second interpolation processing that are mixed when being interpolated, but also can set a value of “0” or “1” which represents 0:100% or 100%:0.

By applying the present invention in this way, the pixels interpolated separately in two modes of interpolation processing are blended, based on an evaluation function that depends on reference pixel data, and therefore, it is feasible to prevent an error in selecting an interpolation method, based on the appraised attribute of the image for which interpolation is executed.

The above second function of determining a blending ratio determines a blending ratio, based on print quality setting. There is a causal relationship between print quality setting and interpolation processing result; e.g., with low print quality setting, even if interpolation processing is executed to avoid affecting subtle tone gradation, its effect is not reflected in the print result. By determining a blending ratio, based on print quality setting, a higher percentage of either the above first interpolation processing or second interpolation processing which is suitable can be set when a blending ratio is determined, according to the effect of the interpolation processing on the print result. As a concrete example, it is conceivable to use an evaluation function that depends on print quality setting. Based on the value of such evaluation function, a blending ratio can easily be determined.

By applying the present invention in this way, a blending ratio can easily be calculated, based on the value of the above evaluation function.

As an example of constitution for setting a higher percentage of either interpolation processing whose effect is visually noticeable, based on print quality setting, in this way, the invention is constituted in another aspect such that the above second function of determining a blending ratio sets a higher percentage of the above second interpolation processing when determining a blending ratio when the above print quality parameters acquired indicate higher print quality. Because the above second interpolation processing interpolates pixels without affecting the tone gradation, in order to obtain print results that subtle tone gradation reproduced in the interpolated pixels will also be reproduced thereon, print quality must be high; otherwise, this processing is meaningless, or ineffective. By setting a higher percentage of the second interpolation processing when determining a blending ratio when higher print quality is set, the pixels separately interpolated in both modes can be blended, according to the print quality setting.

By applying the present invention in this way, blending the pixels separately interpolated in both modes, according to the print quality setting, can easily be performed.

Although there are a variety of possible manners in which the second function of determining a blending ratio is designed to operate in this way, as an example of such constitution, the invention is constituted in another aspect such that the above second function of determining a blending ratio inhibits only the above first interpolation processing from being active when the above print quality parameters acquired indicate high print quality. The above first interpolation processing does not decrease the degree of tone value difference between the pixels, but tends to affect the above tone gradation. If only the first interpolation processing is active when high quality printing is performed, there is a possibility of printing from the interpolation data that does not reproduce the tone gradation of the source image at all. Thus, a blending ratio is determined to inhibit only the first interpolation processing from being active when high quality printing is performed, thereby eliminating

By applying the present invention in this way, there is no possibility of a decisive error occurring in selecting an interpolation method relating to print results.

Hereupon, types of parameters determine print quality setting and the above-mentioned function of print quality parameters acquisition acquires these parameters, thereby the print quality setting can be obtained. For example, when a printing paper parameter is acquired, print quality setting specified by this parameter is obtained. There are a variety of printing paper types, such as glossy paper, plain paper, etc. Even if printing is performed from same image data under same conditions of parameters except the printing paper, the print results on paper of different types are considerably different. The above function of print quality parameters acquisition acquires the printing paper parameter and the above second function of determining a blending ratio determines a blending ratio, based on this paper parameter setting. Thereby, the pixels separately interpolated in both modes can be blended, according to the print quality setting.

By applying the present invention in this way, blending the pixels separately interpolated in both modes, according to the print quality setting, can easily be performed.

Another example of print quality parameter is print speed. Recent printers may be provided with high-speed print mode and low-speed print mode. The former mode prioritizes print speed, but print image quality somewhat decreases. The later mode prioritizes high image quality, but print speed is lower. When a print speed parameter that discriminates between high and low speed is acquired, print quality setting according to this parameter is obtained. The above function of print quality parameters acquisition acquires the print speed parameter and the above second function of determining a blending ratio determines a blending ratio, based on this print speed parameter setting. Thereby, the pixels separately interpolated in both modes can be blended, according to the print quality setting.

By applying the present invention in this way, blending the pixels separately interpolated in both modes, according to the print speed setting, can easily be performed.

Another example of print quality parameter is resolution of print. The precision of prints made by printers is very high, as mentioned above, and pixels are interpolated between dots of source image data before normal printing is performed. Even if printing is performed on same area from source image data of same amount, print results are considerably different by difference of resolution (dpi) of print. When a print resolution parameter is acquired, print quality setting specified by this parameter is obtained. The above function of print quality parameters acquisition acquires the print resolution parameter and the above second function of determining a blending ratio determines a blending ratio, based on this print resolution parameter setting. Thereby, the pixels separately interpolated in both modes can be blended, according to the print quality setting.

By applying the present invention in this way, blending the pixels separately interpolated in both modes, according to the print resolution setting, can easily be performed.

Another example of print quality parameter is ink type. There are pigment ink and dye ink for use on printers. Due to its property, the pigment ink does not easily blur as compared with dye. Edges of the image printed on paper with pigment ink are sharper contrast than edges of the image printed with dye ink. In short, different ink types make different quality prints. Thus, the above function of print quality parameters acquisition acquires the ink type parameter and the above second function of determining a blending ratio sets a lower percentage of the above first interpolation processing when determining a blending ratio if this parameter specifies pigment ink to be used. Thereby, the pixels separately interpolated in both modes can be blended, according to the print quality setting.

By applying the present invention in this way, blending the pixels separately interpolated in both modes, according to the ink type setting, can easily be performed.

The recording medium of the present invention, mentioned hereinbefore, of course, may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. If a communication line is used as a way of distributing the program of the present invention, which is different from the above medium, the communication line is regarded as a distribution medium of the program so that the present invention will be used.

Furthermore, even if part of the present invention is implemented by software and the remaining part is implemented by hardware, this does not differ at all from those set forth herein in the concept of the invention. The present invention may be implemented in such a manner that part of the invention has been recorded into a recording medium in advance and will be read appropriately as required.

The interpolation processing program that can execute two modes of interpolation processing and blends the pixels separately interpolated in both modes, based on the evaluation function dependent on reference pixel data is considered as follows. Processing is carried out under the control of this program and its procedure is based on the invention without doubt, thus it is easily understandable that realizing the invention as the method is also applicable. The aspect of the invention defined in claims 12 to 22 essentially takes the same effect as described above. That is, the invention is not necessarily embodied as a concrete medium and its implementation as the method is correspondingly effective without doubt.

Such program is implemented on a concrete computer. In this respect, it is easily understandable that embodying the present invention as an apparatus comprising such computer is also applicable. The aspect of the invention defined in claims 23 to 33 essentially takes the same effect as described above. Of course, such apparatus may operate singly to carry out the present invention or may be assembled into another equipment to carry out the present invention in conjunction with another method. Not limited to those set forth herein, the concept of the invention comprehends a variety of modes of its embodiment and modifications thereto are possible without departing from the spirit or essential characteristics thereof.

### BRIEF DESCRIPTION OF THE DRAWINGS

FIG. 1 is a block diagram showing an image data interpolation apparatus as a preferred embodiment of the present invention.

FIG. 2 is a block diagram showing the hardware embodiment of the above image data interpolation apparatus.

FIG. 3 is a schematic view of another example of application of the image data interpolation apparatus of the present invention.

FIG. 4 is a schematic view of another example of application of the image data interpolation apparatus of the present invention.

FIG. 5 is a schematic view of another example of application of the image data interpolation apparatus of the present invention.

FIG. 6 is a schematic view of another example of application of the image data interpolation apparatus of the present invention.

FIG. 7 is a flowchart illustrating the process regarding resolution conversion that a printer driver executes.

FIG. 8 is a flowchart of first interpolation processing.

FIG. 9 is a graphical representation of a histogram of luminance values.

FIG. 10 is a graphical representation of application examples of evaluation function F (y).

FIG. 11 is an illustration giving a luminance pattern example of 3×3 pixels.

FIG. 12 is an illustration showing a zone comprising 5×5 reference pixels.

FIG. 13 is an illustration giving edge pattern examples.

FIG. 14 is a conceptual representation of the nearest method.

FIG. 15 is an illustration wherein data of the grid points is copied to their nearest points to be interpolated by the nearest method.

FIG. 16 is a schematic illustration showing the state of the pixels before interpolation by the nearest method.

FIG. 17 is a schematic illustration showing the state of the pixels after interpolation by the nearest method.

FIG. 18 is a conceptual representation of the cubic method.

FIG. 19 is a graphical representation showing how pixel data changes when the cubic method and its variant are applied.

FIG. 20 is a tabulation of pixel data obtained as a cubic method application example.

FIG. 21 is a tabulation of pixel data obtained as an M-cubic method application example.

FIG. 22 is an illustration showing how the pixels, separately interpolated in two modes, are blended and supplied to image data.

FIG. 23 is a schematic block diagram of a color printer of ink jet type.

FIG. 24 is a schematic illustration of a print head unit of the above color printer.

FIG. 25 is a schematic illustration showing a mechanism of jetting color ink out of the above print head unit.

FIG. 26 is a flowchart of image data flow in the printing system.

FIG. 27 is a schematic illustration showing a bubble jet mechanism of jetting color ink out of the print head.

FIG. 28 is a schematic illustration of an electrophotographic printer.

FIG. 29 is a block diagram showing the outline configuration of the printing system.

FIG. 30 is a flowchart illustrating the process regarding print processing that a printer driver executes.

FIG. 31 is an illustration showing a window for printing operation.

FIG. 32 is an illustration showing a window for printer setup operation.

FIG. 33 is a graphical representation of application examples of evaluation function F (y).

FIG. 34 is a schematic diagram giving an overview of the first preferred embodiment of the present invention.

FIG. 35 is a schematic diagram giving an overview of a second preferred embodiment of the present invention.

FIG. 36 is a flowchart illustrating decisions to be made, subject to the conditions for an edge with an angle of 45 degrees.

FIG. 37 is a flowchart illustrating decisions to be made, subject to the conditions for an edge with an angle of 30 degrees.

FIG. 38 is an illustration showing source pixels and pixels of interpolations to be generated from the target source pixel, where it is assumed that a horizontal edge has been found and the magnifying rate of two times applies.

FIG. 39 is an illustration showing source pixels and pixels of interpolations to be generated from the target source pixel, where it is assumed that an angular edge has been found and the magnifying rate of two times applies.

FIG. 40 is an illustration showing source pixels and pixels of interpolations to be generated from the target source pixel, where it is assumed that an edge with an angle of 45 degrees has been found and the magnifying rate of two times applies.

FIG. 41 is a flowchart illustrating decisions to be made, subject to the conditions for an edge with an angle of 45 degrees.

FIG. 42 is an illustration showing source pixels and pixels of interpolations to be generated from the target source pixel, where it is assumed that an edge with an angle of 30 degrees has been found and the magnifying rate of two times applies.

FIG. 43 is a flowchart illustrating decisions to be made, subject to the conditions for an edge with an angle of 30 degrees.

### DESCRIPTION OF THE PREFERRED EMBODIMENTS

Preferred embodiments of the present invention will now be described, based on the drawings.

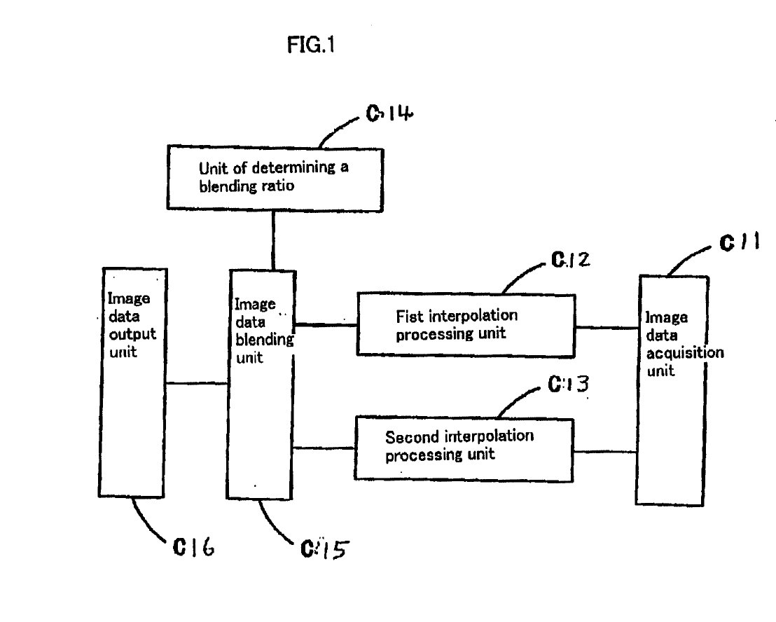

FIG. 1 is a block diagram showing the primary configuration of an image data interpolation apparatus as a preferred embodiment of the present invention.

When digital processing is assumed, an image is represented in dot matrix pixels and image data comprises all pixel data of the image. In the mode of image processing in units of pixels, image enlargement and reduction are performed in units of pixels. The present image data interpolation apparatus performs such image enlargement processing in units of pixels. An image data acquisition unit C11 acquires such image data and a first interpolation processing unit C12 and a second interpolation processing unit C13 perform interpolation processing by which the number of pixels constituting the image data multiplies. The first interpolation processing unit C12 is able to execute the pattern matching method and the nearest method as interpolation processing. The second interpolation processing unit C13 is able to execute the cubic method as interpolation processing.

A first unit of determining a blending ratio C14 appraises the attribute of the image, based on reference pixels around a pixel for which interpolation is just now executed in the image data acquired by the image data acquisition unit C11, and determines a blending ratio between the pixels interpolated by the first interpolation processing unit C12 and those interpolated by the second interpolation processing unit C13, based on the above attribute. Once the first unit of determining a blending ratio C14 have determined a blending ratio, an image data blending unit C15 blends the data of the pixels interpolated by the first interpolation processing unit C12 and the data of the pixels interpolated by the second interpolation processing unit C13 at that blending ratio. Then, an image data output unit C16 outputs the pixels of interpolations data blended by the image data blending unit C15.

In the present embodiment of the invention, as an example of the hardware embodiment of the above image data interpolation apparatus, a computer system 10 is applied.

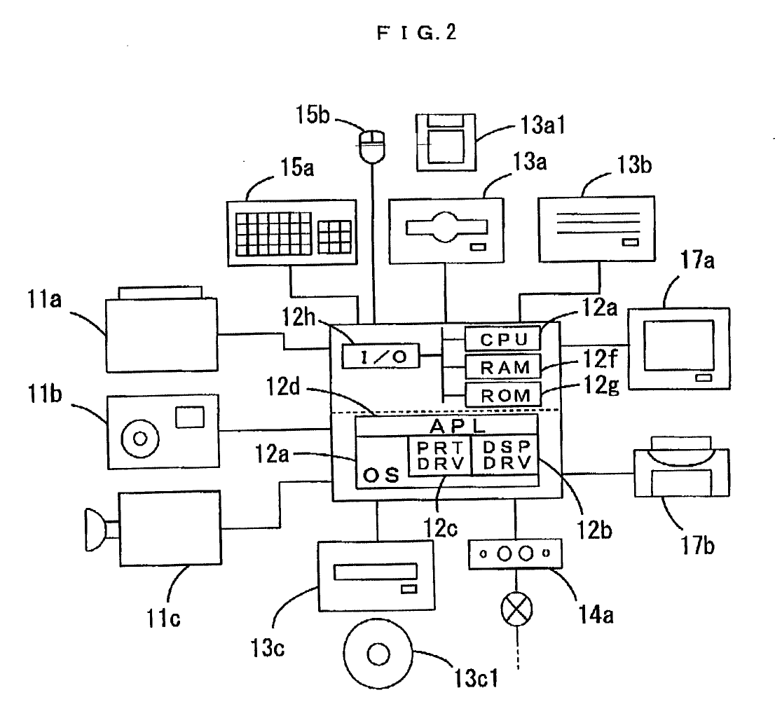

FIG. 2 is a block diagram showing this computer system 10.

This computer system 10 is equipped with a scanner 11a, a digital still camera 11b, and a video camera 11c as image input devices connected to a computer main unit 12. These input devices are able to generate image data represented dot matrix pixels of an image and output such data to the computer main unit 12. Such image data enables image representation in about 16,700,000 colors by varying 256 tones of the three primary colors of R, G, and B.

To the computer main unit 12, a floppy disk drive 13a, a hard disk 13b, and a CD-ROM drive 13c are connected as external auxiliary storage. System-related main programs are stored in the hard disk 13b and other programs, if necessary, can be read from a floppy disk 13a1 and a CD-ROM 13c1.

As a communication device for connecting the computer to an external network, a modem 14a is connected to the computer main unit 12 to enable the computer to connect to the external network via a public communication line, so that software and data can be downloaded into the computer across the communication line. Although, in this example, the modem 14a enables access to the external over a telephone circuit, a LAN adapter may be attached to the computer so that access to a network can be made via the LAN adapter. To the computer main unit 12, moreover, a keyboard 14a and a mouse 15b for operating the computer are connected.

Furthermore, the computer is equipped with a display 17a and a color printer 17b as image output devices. The display 17a has a display area of horizontal 800 pixels by vertical 600 pixels and can display each pixel in the above-mentioned color range of 16,700,000 colors. This resolution is, of course, only an example, and the resolution can be modified appropriately; e.g., 640×480 pixels, 1024×768 pixels, and so on.

The color printer 17b is an ink jet printer and can print an image by printing the dots of the image on printing paper which is an image recording medium, using inks of four colors, C, M Y, and K. In addition to normal density of 360×360 dpi of an image printed by the printer, the printer is capable of high density printing with density of 720×720 dpi, and is provided with two options of tone representation; either color ink print or colorless.

Meanwhile, inside the computer main unit 12, given programs run to input an image to the computer via any of the above image input devices while outputting an image to either output device. Among such programs, an operating system (OS) 12a runs as a basic program. In the operating program 12a, a display driver (DSP DRV) 12bc that controls the display 17a to make image display and a printer driver (PRT DRV) 12c that controls the printer 17b to make image print output are assembled. These drivers 12b and 12c depend on the model of the display 17a and the model of the color printer 17b and can be added to or removed from the operating system 12a, according to the display model and the printer model selected for use. Moreover, either driver can implement additional function beyond the standard processing scope, dependent on the model selected for use. That is, even if any driver is assembled into the operating system 12a, a common processing system is maintained by the standard operating system 12a, while a variety of additional processing can be implemented, according to the driver within a permissible range.

Inside the computer main unit 12, of course, essential components are installed for running such programs: CPU 12e, RAM 12f, ROM 12g, and I/O interface 12h. The CPU 12e that performs arithmetic operation appropriately executes the basic program written into the ROM 12g, while using the RAM 12f as temporary working area, setting save area or program area, and controls the external devices connected to the computer via the I/O interface 12h as well as the internal components.

Application 12d is run on the operating system 12a as the basic program. The application 12d executes a wide range of processing: it watches for the operation of a keyboard 15a and a mouse 15b which are the operation devices; when such device is operated, it appropriately controls kinds of external devices and executes the appropriate operation; and it displays the result of operation on the display 17a or sends the result to the color printer 17b.

In the above computer system 10, image data is acquired by the scanner 11a which is an image input device. After processed by the application 12d, according to predetermined image processing, the image data can be output to either image output device; it may be displayed on the display 17a or sent to the color printer 17b from which it is printed. Here, simply take notice of the correspondence between the pixels of the source image and the pixels of the printed image. If the density of the pixels of the image printed by the color printer 17b matches the density of the pixels of the image scanned by the scanner 11a, the scanned source image and the printed image are of same size. If the former density is different from the latter density, the size of the printed image is different from the size of the scanned image. Most models of the scanner 11a are capable of scanning images with the density of pixels corresponding or approximating to that of the color printer 17b. However, in many cases, the density of pixels of images printed by the color printer 17b which is designed to enhance the density of pixels for high quality image printing is generally higher than the density of pixels provided by general image input devices. Especially, as compared with the density of pixels of an image displayed on the display 17a, the density of pixels of that image printed by the color printer is significantly higher. When the data of an image displayed on the display 17a is sent to the printer and the image is printed in the corresponding number of pixels, there is a possibility of the extremely reduced image being printed.

By reason hereof, resolution conversion in executed to eliminate the difference in the density of pixels between practically used devices, while the operating system 12a sets standard density of pixels. If the resolution of the display 17a is, for example, 72 dpi, and if the operating system 12 sets a standard resolution of 360 dpi, the display driver 12b executes resolution conversion from 72 dpi to 360 dpi. If the resolution of the color printer is 720 dpi, and if the same standard resolution applies, the printer driver 12c executes resolution conversion.

The resolution conversion is a processing by which the number of pixels constituting the image data multiplies and thus corresponds to interpolation processing. The above display driver 12b and printer driver 12c execute the interpolation processing as one of their functions. Hereupon, the display driver 12b and printer driver 12c are able to execute interpolation as the above-described first interpolation processing unit C12 and second interpolation processing unit C13 do, and furthermore execute processing as the first unit of determining a blending ratio C14, the image data blending unit C15, and the image data output unit C16 do. These drivers are designed to blend the pixels interpolated by the first interpolation processing and those interpolated by the second interpolation processing at a ratio, according to the attribute of the image of input.

These display driver 12b and printer driver 12c are stored in the hard disk 13b and put into operation after read to the computer main unit 12 when the computer is booted up. Either driver is installed as follows: set a medium such as a CD-ROM 13c1 or a floppy disk 13a1 whereon these drivers have been recorded in the appropriate drive and install it from the medium into the hard disk. Thus, such medium corresponds to the medium whereon the image data interpolation program has been recorded.

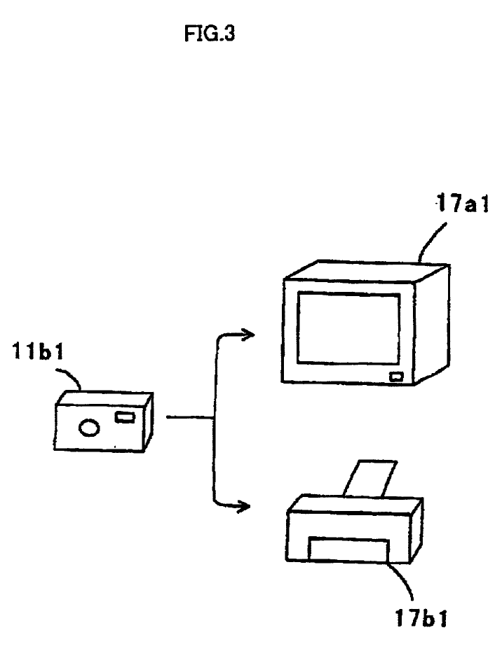

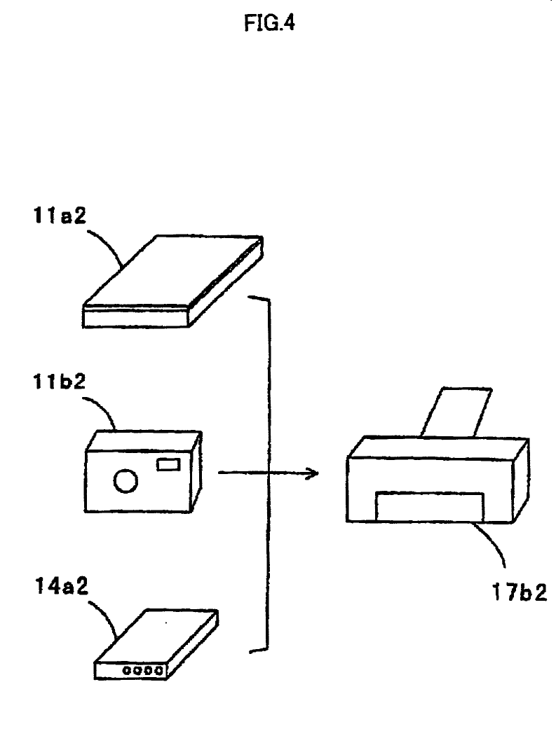

Although the image data interpolation apparatus is embodied as the computer system 10 in the present embodiment of the invention, such computer system is not necessarily required. Instead, a system may be used that can implement the similar functions required for image data interpolation processing. For example, a system which is shown in FIG. 3 is feasible, where a chip equivalent to the image data interpolation apparatus for executing interpolation processing is assembled into a digital still camera 11b1 and interpolation-processed image data by the chip is input to a display 17a1 or a color printer 17b1 so that an interpolation-processed image is displayed or printed. Moreover, a color printer 17b2 that prints an image after image data is input thereto without the intervention of a computer system, as is shown in FIG. 4, can be configured to implement the interpolation, according to the present invention, so that it will automatically execute resolution conversion of image data input through a scanner 11a2, a digital still camera 11b2, or a modem 14a2 and print the image.

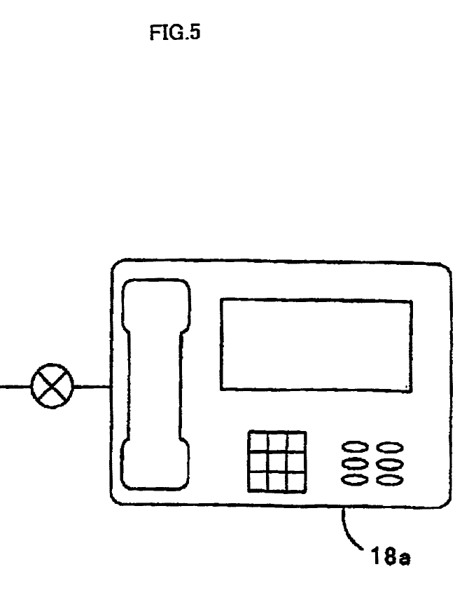

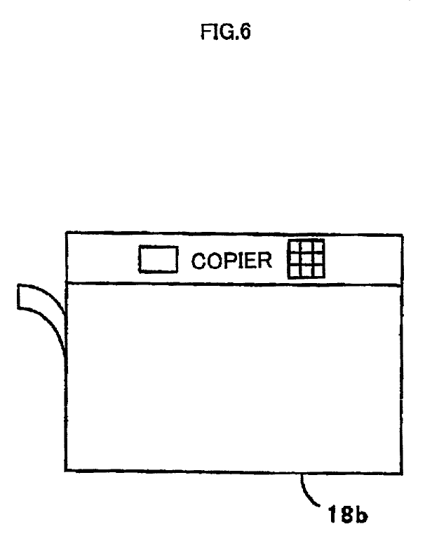

In addition, the prevent invention is, of course, applicable to types of equipment for image data processing, such as color facsimile equipment 18a, which is shown in FIG. 5, and color copy equipment 18b which is shown in FIG. 6.

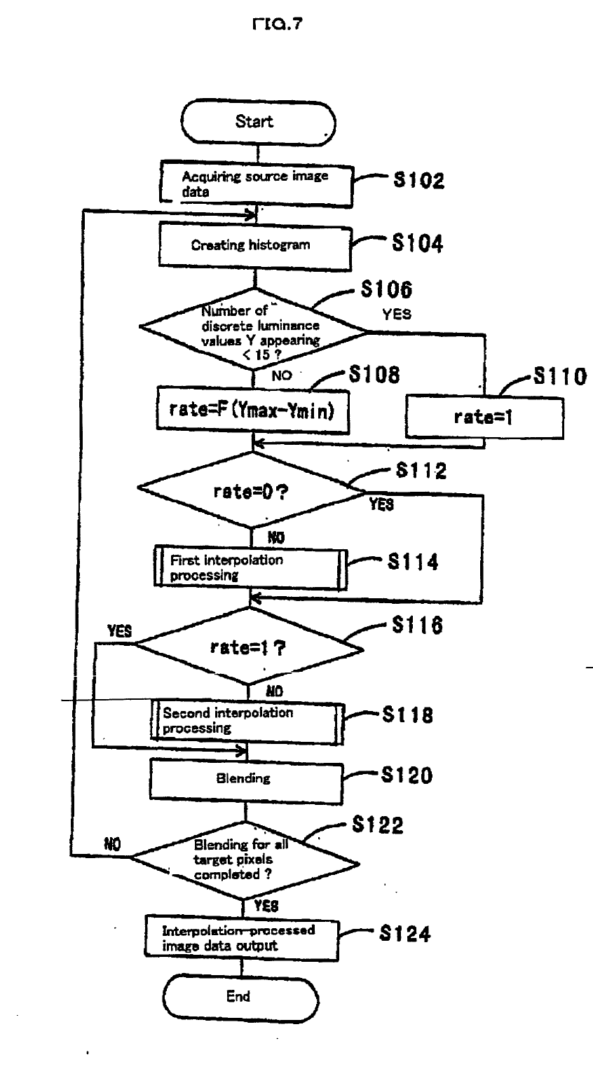

FIG. 7 is a flowchart illustrating the software operation flow regarding the resolution conversion that the above printer driver 12c executes. In FIG. 7, source image data is acquired in step S102. During process sequence in which an image is scanned by the scanner 11a under the control of the application 12d, the image data is processed by predetermined image processing, and printing from the image data is executed, the printer driver 12c acquires print data of predetermined resolution via the operating system 12a and this stage corresponds to the step S102. The processing of this step is regarded as the step or function of image data acquisition from the software point of view. However, it can be understood that the description of all steps including this step of image data acquisition to be executed by the computer does not directly include the operation of the operating system 12a itself and hardware. On the other hand, if this step is considered to be implemented as part of the organically integrated operation of the hardware including the CPU, it corresponds to the action of the image data acquisition unit C11.

In step S104, a pixel in the read image data is set as a target of interpolation, the pixel data in a zone comprising 5×5 pixels around the target pixel is set to be reference pixels, and a histogram of the luminance values of the reference pixels is created. In step S106, the number of discrete luminance values appearing in the created histogram is counted and judgment is made as to whether this count is less than 15. The greater the number of discrete luminance values, the greater will be the number of colors assigned to the reference pixels. From this fact, if the number of discrete luminance values appearing in the histogram is less than 15, the reference pixels are regarded as tho pixels belonging to a non-natural picture. When the judgment is the above step S106 is that the number of discrete luminance values appearing is less than 15, the blending ratio (hereinafter referred to as the rate) of interpolations by the above first interpolation processing to those by the second interpolation processing is set to 1 in step 110.

When the judgment in the step S106 is that the number of discrete luminance values appearing is not less than 15, the rate is determined by an evaluation function F in step S108. This evaluation function F, which will be detailed later, is a function of the width of the range within which the luminance values of the above reference pixels fall, that is, the difference between the maximum luminance value Ymax and the minimum luminance value Ymin among the reference pixels. Thus, the sequence of the steps S104, S106, S108, and S110 corresponds to the first step or function of determining a blending ratio. If these steps are considered to be implemented as part of the organically integrated operation of the hardware including the CPU, they are defined as the action of the first unit of determining a blending ratio C14.

After the rate is determined in the step S108 or the step S110, judgment is made as to whether the rate is “0” in step S112. When the rate is “0,” the first interpolation processing is not executed. When the judgment in the step S112 is that the rate is other than “0,” the first interpolation processing is executed in step S114. Thus, this step corresponds to the step or function of first interpolation processing. If this step is considered to be implemented as part of the organically integrated operation of the hardware including the CPU, it is defined as the action of the first interpolation processing unit C12.

Then, in step S116, judgement is made as to whether the rate is “1.” When the rate is “1,” the second interpolation processing in not executed. When the judgment in the step S116 is that the rate is not “1,” the second interpolation processing is executed in step S118. Thus, this step corresponds to the step or function of second interpolation processing. If this step is considered to be implemented as part of the organically integrated operation of the hardware including the CPU, it is defined as the action of the second interpolation processing unit C13. After the rate is determined in this way and the first and/or second interpolation processing is executed, in step S120, blending of pixel data of interpolations is performed, according to the following equation, where the set rate shall be assigned, and then pixels of interpolations are generated in step S120.

Data to be blended=(First interpolation)×rate+(Second interpolation)×(1−rate) (1)

Thus, this step corresponds to the step or function of image data blending. If this step is considered to be implemented as part of the organically integrated operation of the hardware including the CPU, it is defined as the action of the image data blending unit C15. Upon the completion of the above sequence of generating data of interpolations to the target pixel, judgment is made as to whether blending of interpolated data has been completed for all target pixels in the input source image data in step S122. If not, the step S104 and subsequent steps are repeated until blending of interpolated data has been completed for all target pixels. Upon the completion of blending of interpolated data for all target pixels, the interpolation-processed image data is output in step S124. For the printer driver 12c, print data is not obtained only by resolution conversion; color conversion and halftone processing are further required. Thus, the image data output just means transferring the data to the next stage and the processing of this step corresponds to the step or function of image data output. If this step is considered to be implemented as part of the organically integrated operation of the hardware including the CPU, it is defined as the action of the image data output unit C16.

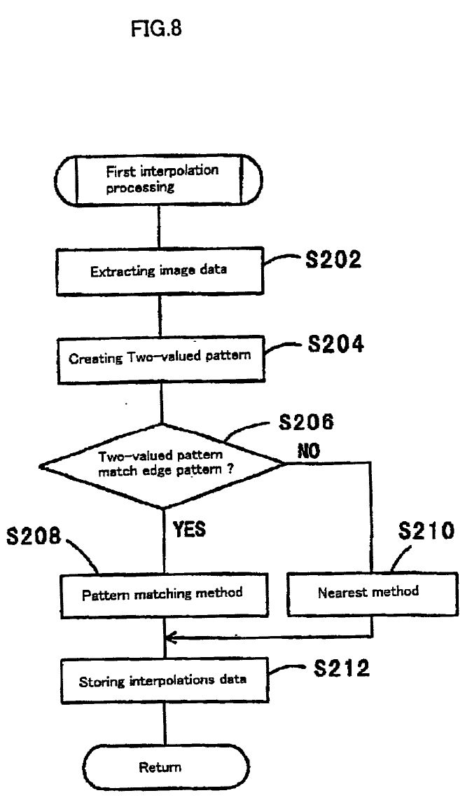

Next, the detailed flow of the first interpolation processing in the step S114 in the above flowchart will be explained below. FIG. 8 is a flowchart illustrating the flow of the first interpolation processing. In step S202 in FIG. 8, from the pixel data in the zone comprising 5×5 pixels obtained in the above step S104, further, pixel data in a zone comprising 3×3 pixels around the target pixel is extracted for pattern matching. In step S204, from the thus extracted pixel data, a two-valued pattern of the pixels is created, depending on the luminance values of the extracted pixels are greater than a predetermined threshold which will be described later.

In step S206, judgment is made as to whether the two-valued pattern of the pixels created in the step S204 matches a predetermined edge pattern which has been prepared in advance. Here, the edge pattern is a two-valued pattern of the pixels, representing an edge with an angle, for example, 30°, 45°, etc., formed in the above zone comprising 3×3 pixels. By judging whether there is a match between such edge pattern and the two-valued pattern of the pixels created in the above step S204, judgment is made as to whether the zone comprising 3×3 pixels is an edge.

If the judgment in the step S206 is that both patterns match, pixels of interpolations are generated by a predetermined rule, according to the above edge pattern, in step S208. The interpolation processing to be applied when the patterns match is represented by the pattern matching method in the flow. If the judgment in the step S206 is that both patterns do not match, pixels of interpolations are generated by the nearest method in step S210. After the interpolation processing of the target pixel is executed in this way, the result data of interpolation is stored into the RAM 12f in step S212 which is followed by the return to the above flow shown in FIG. 7.

Then, detailed processing for each step in the above flowcharts will be explained below. In the present embodiment of the invention, judgment is made as to whether the source image acquired in the step S102 belongs to computer graphics (non-natural pictures) or photography (natural pictures) and the result of the judgment is reflected in setting a blending ratio between the first and second interpolations. To prevent incorrect selection of an interpolation method to be applied, based on the appraised attribute of the image for which interpolation is executed, it is, of course, possible to avoid fixing the above-mentioned rate to “1” or “0.” However, in the present embodiment, if the number of discrete luminance values appearing in the reference pixels is less than 15, the pixels are regarded as those belonging to a non-natural picture. This is because the inventor considers it more important to avoid the application of the second interpolation processing to non-natural pictures; otherwise, the second interpolation would make contours vague in a non-natural picture.

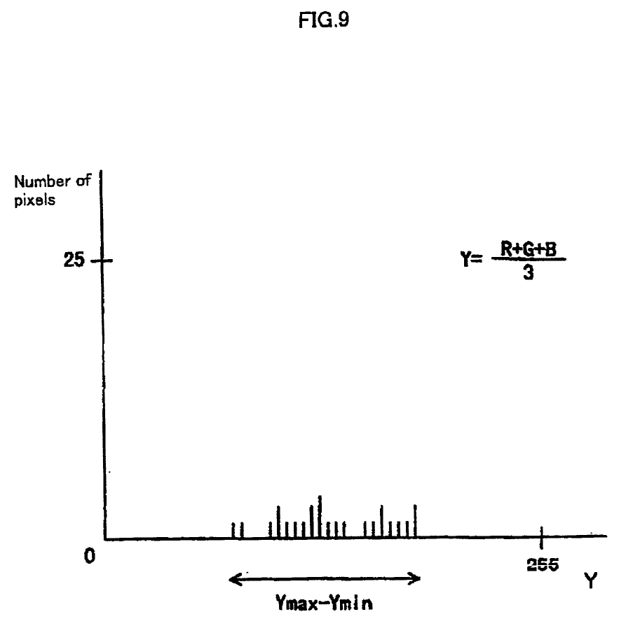

For the above judgment, a histogram of luminance values, which is shown in FIG. 9, is used. In the step 104, the luminance values of the reference pixels in the zone comprising 5×5 pixels are obtained and a histogram is created to show how the pixels are distributed in the range of their luminance values. The number of discrete luminance values appearing in the histogram, that is, how many luminance values appear for which the number of distributed pixels is other than “0” is counted, based on which, the judgment in the step S106 is made. Among 1,670,000 colors, of course, a plurality of colors of same luminance exist on one image. When taking notice of comparison between natural and non-natural pictures, quantitative comparison can be performed, whether the number of discrete colors or the number of discrete luminance values, based on which the comparison is made. In addition to the luminance values, the number of discrete colors appearing in the reference pixels may be counted, based on which judgment may be made as to whether the pixels belong to a non-natural picture.

If the pixel data of the reference pixels includes luminance as its component factor, distribution of the pixels can be obtained by using the luminance values of the pixels. However, even for some image data that does not include luminance values as its direct component values, the data would include component values indirectly representing luminance. Thus, by converting color solid space in which luminance values are not direct component values to color solid space in which luminance values are direct component values, luminance value can be obtained.

Color conversion between different coordinate systems of color solid space is not definitely formulated by a conversion formula. Mutual correspondence between component values on the coordinates of different color space systems must be obtained and a color conversion table that retains this correspondence created. By referring to this table, one-to-one color conversion must be executed. Exactly speaking, thus, a color conversion table containing 167,000,000 color elements must be prepared. As a result of considering the efficient use of storage resources, mapping of correspondence between different color components for all coordinate values is not feasible. Normally, mapping of correspondence between different color components at properly spaced grid points is prepared and arithmetic of interpolation is additionally applied. However, because such arithmetic of interpolation involves a number of operations of multiplication and addition, a great amount of arithmetic processing is required.

If a full color conversion table as used, the amount of processing is reduced, but the table size expands so extremely that is considered infeasible. If the table size is reduced to practically reasonable size, the amount of processing often increases so extremely that is considered infeasible. In view hereof, a simple method of luminance value calculation is taken in the present embodiment of the invention. Image data for which interpolation is executed is based on the color solid space of R, G, and B and each color component value represents brightness of color. By viewing the R, G, and B component values separately, the property of linear relation to luminance is found equally for all the components. Thus, it can be said that data reflects the luminance value of a pixel without considering the rates of the colors to be added even when we simply apply the following:

Y=(R+G+B)/3

By using this formula, luminance values of pixels are calculated in the present embodiment of the invention.

Of course, calculating luminance values of pixels is not only based on this method. As is applied to televisions, the following conversion formula by which the luminance of a pixel is obtained from the three primary colors of R, G, and B may be used:

Y=0.30R+0.59G+0.11B

If this formula is used, luminance values of pixels can be obtained only by carrying out multiplication three times and addition two times.

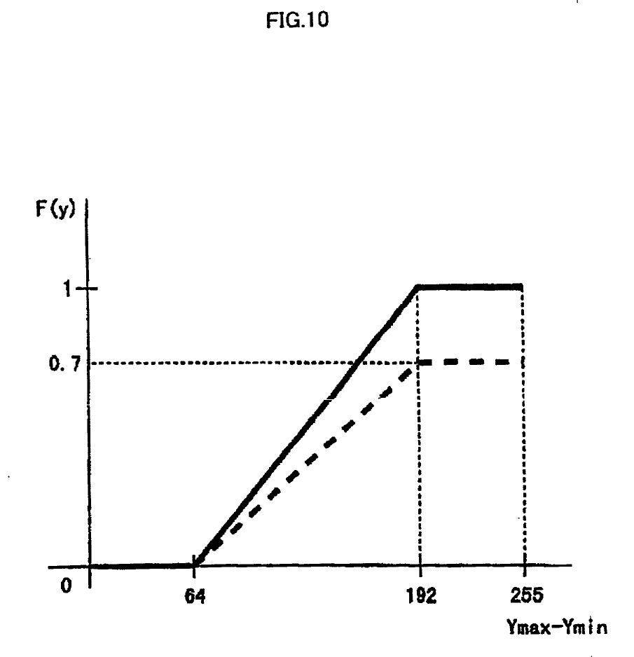

After the luminance values of the reference pixels are thus obtained, if 15 or more discrete luminance values for which the number of distributed pixels is other than “0” appears in the histogram, a blending ratio (of the first interpolation to the second interpolation), namely, a rate is determined by a predetermined evaluation function F in the step S108. A solid line, which is shown in FIG. 10, is an example of such evaluation function F (y). The evaluation function has a value when “y” falls within the range that 0≦y≦255 and varies in the range that 0≦r (y)≦1. F (y) is 0 in the range that 0≦y≦64 and 1 in the range that 192≦y≦255. F (y) linearly increases from 0 to 1 in the range that 64≦y≦192. Hereupon, the width of the range within which the luminance values falls, “Ymax-Ymin,” shown in FIG. 7, is assigned to “y.” Thus, the greater the value of this width, that is, the reference pixels make edge-like visualization due to mutual relation in luminance, the greater will be the rate.

The evaluation function that sets the rate greater for such edge-like visualization is not limited to the function example shown in FIG. 10. As the evaluation function, any function may be used that shows the characteristic: when the width of the range of the luminance values is assumed variable, the function value increases monotonously as the value of the width increases. It is not necessary that the maximum value of the evaluation function be set to “1” and the minimum value be set to “0.” The maximum value of the evaluation function may be set at “0.7” to prevent the execution of only the first interpolation processing. This function example is represented by a dotted line shown in FIG. 10. Alternatively, an evaluation function whose value gradually changes over the range of luminance values of 0 to 255 may be used.

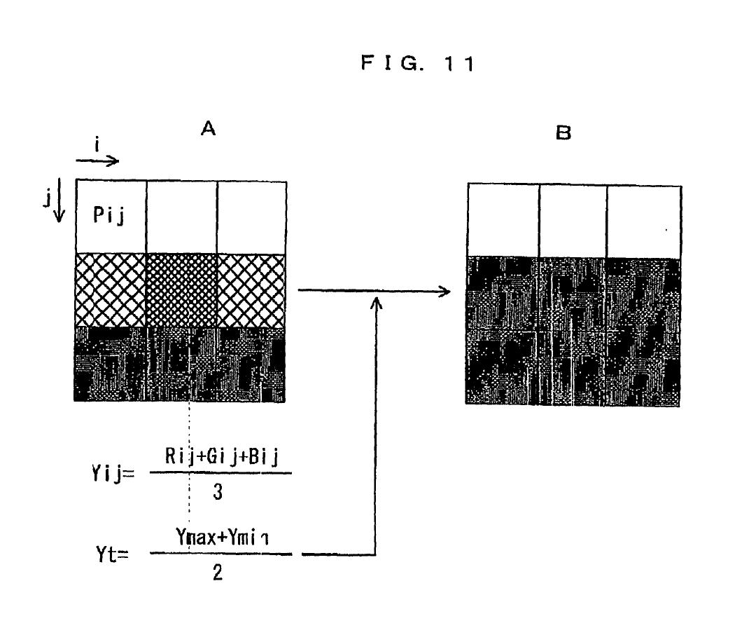

In the histogram shown in FIG. 9, because there are 19 luminance values for which the number of distributed pixels is other than “0,” after the affirmative judgment is made in the step S106, a rate is determined by the evaluation function shown in FIG. 10 in the step S108. Then, the first interpolation processing in the step S114 and the second interpolation processing in the step S118 are executed. FIG. 11A gives an example of a luminance pattern of 3×3 pixels, extracted in the step S202 in FIG. 8. In the step S204, a two-valued pattern of the pixels, whose example is given in FIG. 11B, is created from the luminance pattern shown in FIG. 11A. Firstly, for all the pixels Pij, their luminance values Yij are calculated, according to the above luminance value calculation formula.

A means value between the maximum value Ymax and the minimum value Ymin of the thus obtained luminance values of the pixels is calculated and this means value is set as the above-mentioned threshold Yt. After the threshold is calculated, by comparing each pixel's luminance value Yij with the threshold Yt, the pixels are divided into those having a luminance value above the threshold and those having a luminance value below the threshold and the pattern of the pixels is converted to a two-valued pattern of the pixels. Of course, methods of selecting a threshold and creating a two-valued pattern of the pixels are not limited to the above ways. A variety of manners thereof can be taken; e.g., a means luminance value of 128 is set as the threshold; if there are extremely low luminance values that are less than “45,” these values are ignored and the minimum value is set at “45.”

Once a two-valued pattern of the pixels shown in FIG. 11B has been created, the judgment is made in the step S206 as to whether the two-valued pattern matches one of edge patterns that have been prepared in advance. Hereupon, various types of edge patterns can be used as the prepared ones. It is assumed that the pattern of the pixels shown in FIG. 11B matches one of the prepared edge patterns. Because of matching with an edge pattern, the pattern shown in FIG. 11B shows a characteristic that the difference between the luminance values of the pixels positioned on the upper side in the j direction of the figure and those of the pixels positioned on the lower side in the j direction of the figure tends to be great, but the luminance difference in the horizontal direction on paper is little. Thus, this pattern is regarded as a horizontally parallel edge. To this edge pattern, pixel interpolation processing is then executed, according to a predetermined rule.

Types of rules may be predetermined for types of edge patterns. In principle, for given pixels in the above zone comprising 3×3 pixels, a weighted average of the tone values of the pixels is calculated with each pixel being given a weight of reciprocal ratio of its distance from its corresponding pixel to be interpolated. Hereupon, we can conceive variations regarding what policy should be applied for selecting pixels in the zone and calculating the above weighted average on the pixels to generate pixels of interpolations and how to reflect the angle and direction of the edge in generating thereof. In a sense that a predetermined variation thereof is set for a particular edge pattern, pixel interpolation processing is executed, according to a predetermined rule for an edge pattern.

Although the above edge patterns are formed in the zone comprising 3×3 pixels, the above reference 5×5 pixels are also used to distinguish the above angle and direction of the edge. A database of a variety of two-valued edge patterns must be prepared in advance. If these predetermined patterns are prepared by being formed in the zone comprising 5×5 pixels, the number of the patterns becomes huge. In the present embodiment of the invention, a practicable number of edge patterns are prepared by being formed in the zone comprising 3×3 pixels and a two-valued pattern of the pixels in that zone is generated. After judgment is made as to whether the two-valued pattern generated matches one of the edge patterns, the zone comprising 5×5 pixels is referred to for edge property reflection in generating pixels of interpolations.

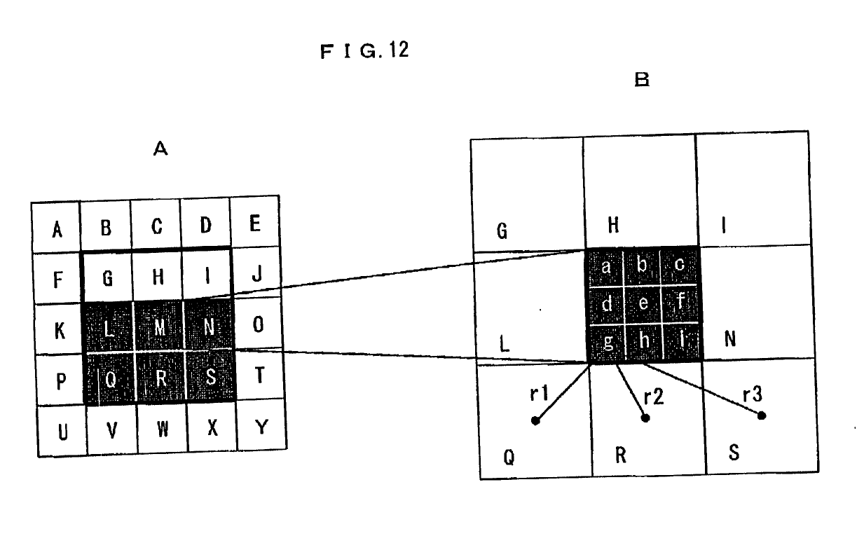

Rules of generating pixels of interpolations if the judgement is the match between the two-valued pattern of the pixels shown in FIG. 11B and the corresponding edge pattern will be explained below. FIG. 12A shows the zone comprising 5×5 pixels which are the above reference pixels data, where each of the pixels is assigned one of A to Y alphabets for identifying each. In this notation, the above zone comprising 3×3 pixels used for pattern matching consists of the G, H, I, L, M, N, Q, R, and S pixels and the above target pixel is the M pixel. FIG. 12A shows the state after a two-valued pattern of the pixels is formed in the zone comprising 3×3 pixels.

FIG. 12B shows the pixels after interpolation processing is executed, where the target pixel M changed to pixel s a to i of interpolations. To generate such pixels of interpolations, calculation is executed, according to a basic formula, which is given below, for calculating a weighted average of the tone values of selected source pixels with each pixel being given a weight of reciprocal ratio of its distance from its corresponding pixel of interpolation.

### Equation 1

$$\overline{x} = \frac{\sum \frac{1}{{r}_{n}} {P}_{n}}{\sum \frac{1}{{r}_{n}}}$$

where, the tone value of a pixel of interpolation to be generated is assumed to be X bar, Pn represents the tone values of the source pixels to be referenced (selected from among G, H, I, L, M, N, Q, R, and S), and rn represents the distance from the pixel of interpolation to be generated to each of the selected source pixels to be referenced.

It is a noticeable feature of this interpolation manner that the tone value of a pixel of interpolation which is generated in this way is obtained from the tone values of the selected source pixels. From the multi-tone pixels, each having a discrete tone value, a two-valued pattern is created, and then pattern matching is carried out. By using the calculation formulas appropriate for a pattern found to match with the two-valued pattern by pattern matching, the tone value of a pixel of interpolation is obtained from the tone values of its surrounding pixels. In this way, judgment by pattern patching is carried out, while a pixel is generated from its surrounding source pixels, based on a predetermined rule that applies, depending on the matched pattern. Thus, natural pixels of interpolations can be generated, which, otherwise, could not be obtained only by interpolation processing based on simple pattern matching. Although calculating the luminance of a pixel from its R, G, and B color component values was executed for reference pixels hereinbefore, the tone value of a pixel of interpolation to be generated, in fact, consists of the R, G, and B values. When calculating the tone value of each pixel of interpolation, exactly, the reference pixels as source pixels are given predetermined weight by using their R, G, and B values. If convenience of calculation is permitted, it is acceptable that the pixels are weighted with their luminance values being in use and the same rate of weight is applied to their R, G, and B values when calculation is executed.

Because this example pattern of pixels formed in the zone comprising 3×3 pixels has little luminance difference in the horizontal direction (the i direction of), that is, a horizontal lengthening edge, the tone values of only three pixels that are placed in a horizontal line are assigned to Pn in the above formula. In principle, the tone values of the source L, M, and N pixels are assigned to Pn. In the present embodiment of the invention, interpolation is executed such that change of luminance in the direction perpendicular to the above horizontally lengthening edge is also reflected in the interpolation. If luminance changes in the direction perpendicular to the horizontally lengthening edge, the tone values of the source Q, R, and S pixels are assigned to Pn so that the appearance of edge change will be reflected in the tone values of the g, h, and i pixels of interpolations. If the luminance value of the target pixel M is greater (smaller) than that of the pixel R forming part of the edge, using the R pixel in addition to the M pixel for interpolation is not effective for highlighting and thus the target pixel shall be used as is.

By reason hereof, the luminance value of the M pixel and that of the R pixel are compared before the calculation for interpolation is executed. If the luminance value of the M pixel is greater than that of the R pixel, the tone values of the above source O, R, and S pixels are assigned to Pn in the above formula and pixels g, h, and i of interpolations are generated. As a result, the luminance values of the g, h, and i pixels of interpolations become greater than those of the d, e, and f pixels of interpolations and the edge is highlighted in the interpolation-processed image data.

The specific condition for making decision in this case is:

((M=edge) & (R>M)) or (M≠edge) & (R<M)

If this is fulfilled, the calculation formulas to be used to generate pixels of interpolations are:

a=d=(Lx2+Mx2+N)/5

b=e=(L+Mx2+N)/4

c=f=(L+Mx2+Nx2)/5

g=(Qx4+Rx6+Sx3)/13

h=(Q+Rx2+S)/4

i=(Qx3+Rx6+Sx4)/13

On the other hand, if the luminance value of the M pixel is less than that of the R pixel, such highlighting is not performed; only the tone values of the source L, M, and N pixels are used.

The specific condition for making decision in this case is:

not((M=edge) & (R>M)) or (M≠edge) & (R<M))

If this is fulfilled, the calculation formulas to be used to generate pixels of interpolations are:

a=d=g=(Lx2+Mx2+N)/5

b=e=h=(L+Mx2+N)/4

c=f=i=(L+Mx2+Nx2)/5

When executing the calculation, according to the above formula, to obtain the tone values of pixels of interpolations, only when the luminance value of the source M pixel is assigned to Pn, half the weight of reciprocal ratio of its distance from its corresponding pixel of interpolation is applied because the weight is too heavy if used as is.

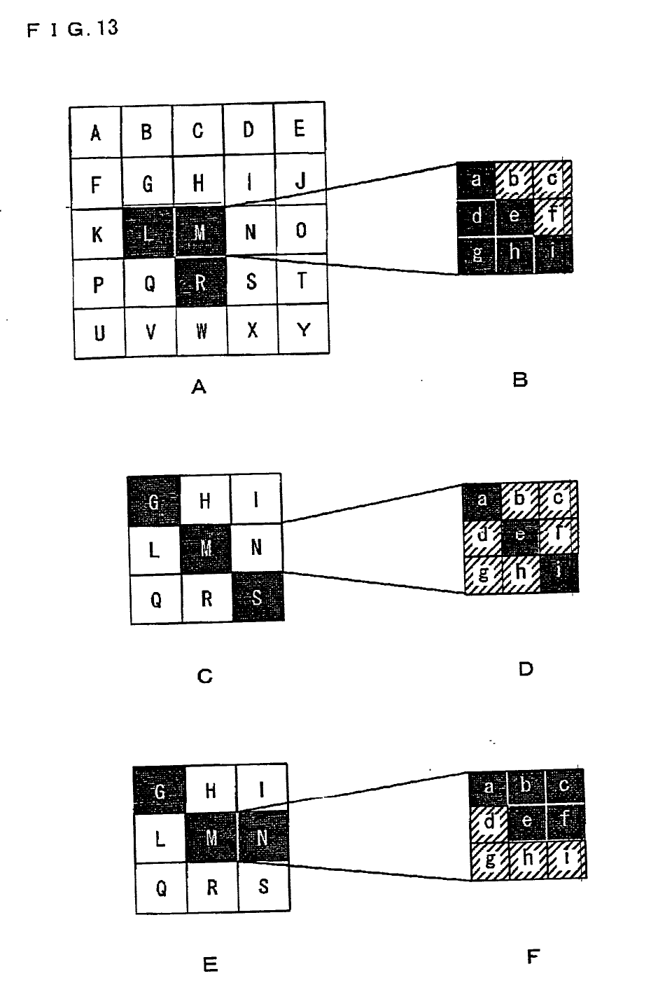

In the present embodiment of the invention, interpolation processing is executed for a horizontal edge, according to the above rules, with luminance change in the direction perpendicular to the edge being taken into consideration. In addition to the horizontal edge, types of edge patterns of pixels can be subjected to interpolation processing and examples thereof are given in FIG. 13. If an edge pattern of pixels, shown in FIG. 13A, is found to be the match in the above step S206, given pixels outside the zone comprising 3×3 pixels as well as given pixels within the zone are referred to and pixels of interpolations are generated, which are shown in FIG. 13B. In the rule applied to this pattern, for the calculation to obtain the tone values of pixels a, d, e, g, h, and i of interpolations, source L, M, and R pixels are used.

For the calculation to obtain the tone values of pixels b, c, and f of interpolations, source pixels to be used differ, according to the luminance values of given pixels that fall within the zone comprising 5×5 pixels. If the pattern is a right-angled edge, source L, M, R pixels are used to generate. If the pattern is not a right-angled edge, source G, H, N, and S pixels are used to generate pixels b, c, and f of interpolations.

First, the condition for deciding that the present pattern is a right-angled edge is:

(((M=K=edge) & (F=not edge)) or ((M=W=edge) & (X=not edge)))

(((M=K=not edge) & (F=edge)) or ((M=W=not edge) & (X=edge)))

If this is fulfilled, the calculation formulas to be used to generate pixels of interpolations are:

c=(L+Mx2+R)/4

b=(Lx4+Mx6+Rx3)/13

f=(Lx3+Mx6+Rx4)/13

a=(Lx2+Mx2+R)/5

d=(Lx3+Mx3+Rx2)/8

e=(L+Mx2+R)/4

g=(L+M+R)/3

h=(Lx2+Mx3+Rx3)/8

i=(L+Mx2+Rx2)5

Then, the condition for deciding that the present pattern is a first pattern approximating to the right-angled edge, though not forming a right angle is:

(((M=F=edge) & (A=not edge)) or (M=X=edge) & (Y=not edge))

or

(((M=F=not edge) & (A=edge)) or ((M=X=not edge) & (Y=edge)))

If this is fulfilled, the calculation formulas to be used to generate pixels of interpolations are:

c=(G+Hx2+Nx2+S)/6

b=(Lx4+Mx6+Rx3)/13

f=(Lx3+Mx6+Rx4)/13

To generate other pixels a, d, e, g, h, and i, the same calculation formulas as for the first condition are used. If neither of the above two conditions for making decision is fulfilled, the calculation formulas to be used to generate pixels of interpolations are:

c=(G+Hx2+Nx2+S)/6

b=(Gx15+Hx30+Nx20+Sx12)/77

f=(Gx12+Hx20+Nx30+Sx15)/77

To generate other pixels a, d, e, g, h, and i, the same calculation formulas as for the first condition are used.

Furthermore, if an edge pattern of pixels, shown in FIG. 13C, is found to be the match, pixels of interpolations are generated, which are shown in FIG. 13D. Because the pattern shown in FIG. 13C is regarded as forming a diagonal line (an edge with an angle of 45 degrees) in the zone comprising 3×3 pixels, source G, M, and S pixels which are elements forming this diagonal line are used to generate pixels a, e, and i of interpolations. At the same time, the edge angle and line thickness of the source pixels are decided, based on the luminance values of given pixels that fall within the zone comprising 5×5 pixels. According to this decision, selection is made between source “H and N” pixels and “G, M, and S” pixels or source “L and R” pixels and “G, M, and S” pixels and the selected pixels are used to generate pixels b, c, f, d, g, and h of interpolations.

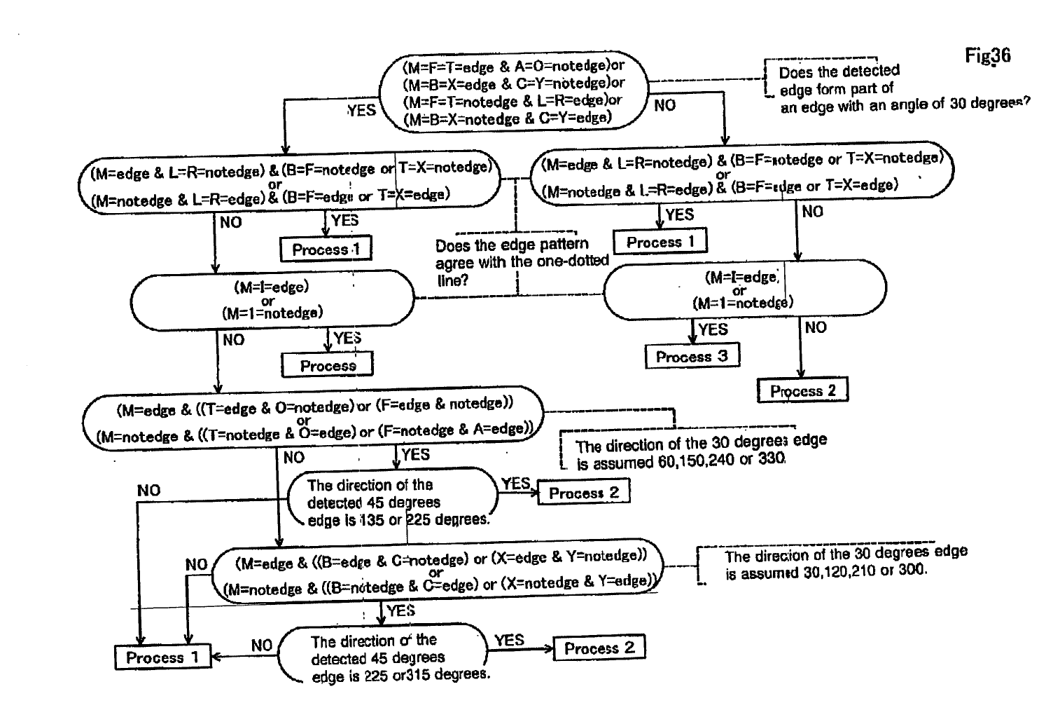

Depending on decision whether the detected edge with an angle of 45 degrees forms part of its extending edge with an angle of 45 degrees or part of an edge with an angle of 30 degrees, the processing flow branches into three processes. The conditions for making this decision and subsequent decisions are specified in FIG. 36. The intention for which each decision is made is described in a box drawn with dotted lines.

If process 1 is selected, the calculation formulas to be used to generate pixels b, c, and f are:

b=(Gx5+Mx10+Sx4)/19

c=(G+Mx2+S)/4

f=(Gx4+Mx10+Sx5)/19.

If process 2 is selected, the calculation formulas to be used to generate pixels b, c, and f are:

b=(Gx5+Mx10+Sx4)/19

c=(H+N)/2

f=(Gx4+Mx10+Sx5)/19

If process 3 is selected, the calculation formulas to be used to generate pixels b, c, and f are:

b=(Hx3+Nx2)/5

c=(H+N)/2

f=(Hx2+Nx3)/5

For generating other pixels, the calculation formula are:

a=(Gx3+Mx6+Sx2)/11

d=(Gx5+Mx10+Sx4)/19

e=(G+Mx2+S)/4

g=(G+Mx2+R)/4

h=(Gx4+Mx10+Sx5)/19

i=(Gx2+Mx6+Sx3)/11

Furthermore, if an edge pattern of pixels, shown in FIG. 13E, is found to be the match, pixels of interpolations are generated, which are shown in FIG. 13F. Because the line pattern shown in FIG. 13E is regarded as a smaller-angled line (an edge with an angle of 30 degrees) than the line shown in FIG. 13C, source G, M and N pixels that form this line pattern are used to generate pixels a, b, c, e, and f of interpolations. At the same time, the edge angle and protrusion of the source pixels are decided based on the luminance values of given pixels that fall within the zone comprising 5×5 pixels. According to this decision, selection is made between source “G, M and N” pixels and “L, R, and S” pixels and the selected pixels are used to generate pixels d, g, h, and i of interpolations.

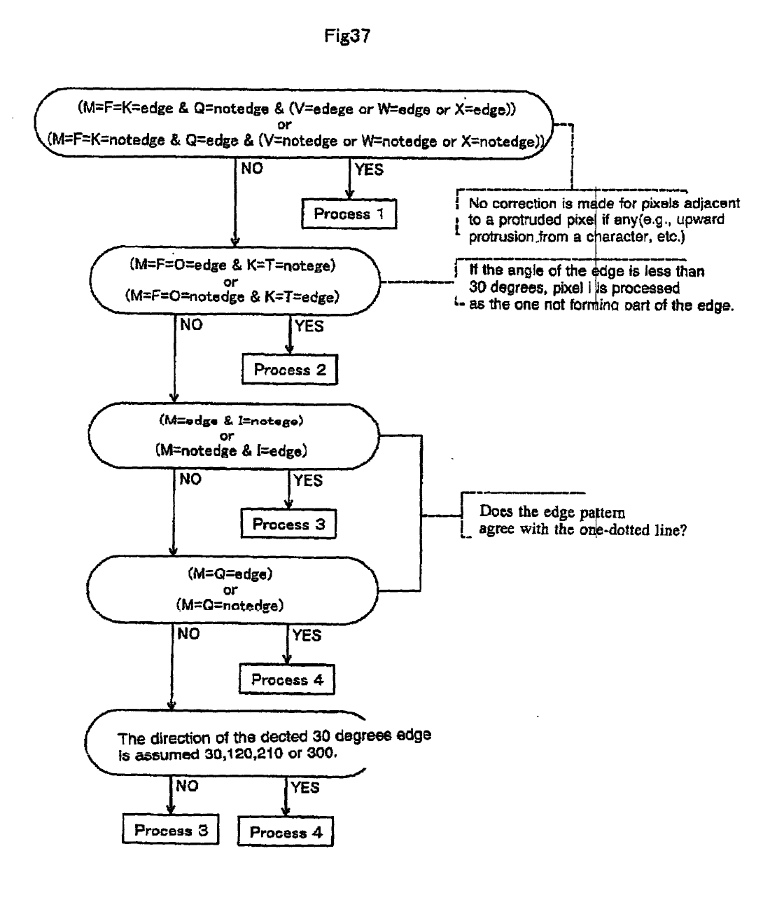

More specifically, the flow of processing for the detected edge with an angle of 30 degrees branches into four processes. The conditions for making decision required for this processing are specified in FIG. 37. The intention for which each decision is made is described in a box drawn with dotted lines.

If process 1 is selected, the calculation formulas to be used to generate pixels d, g, h, and i:

d=(G+Mx2+N)/4

g=(G+Mx2+S)/4

h=(Gx3+Mx8+Nx5)/16

i=(G+Mx3+Nx3)/7

If process 2 is selected, the calculation formulas to be used to generate pixels d, g, h, and i:

d=(G+Mx2+N)/4

g=(Lx2+Rx2+S)/5

h=(Lx4+Rx6+Sx3)/13

i=(Lx3+Rx6+Sx4)/13

If process 3 is selected, the calculation formulas to be used to generate pixels d, g, h, and i:

d=(G+Mx2+N)/4

g=(Lx2+Rx2+S)/5

h=(Lx4+Rx6+Sx3)/13

i=(G+Mx3+Nx3)/7

If process 4 is selected, the calculation formulas to be used to generate pixels d, g, h, and i:

d=(Lx15+Rx10+Sx6)/31

g=(Lx2+Rx2+S)/5

h=(Lx4+Rx6+Sx3)/13

i=(Lx3+Rx6+Sx4)/13

For generating other pixels, the calculation formulas are:

a=(Gx4+Mx6+Nx3)/13

b=(Gx3+Mx6+Nx4)/13

c=(G+Mx2+Nx2)/5

e=(Gx4+Mx6+Nx3)/13

f=(Gx2+Mx5+Nx5)/12

The edge patterns, the method of referring to the zone comprising 5×5 pixels, and the method of selecting source pixels to be used, have been described above for illustrative purposes. A variety of other manners thereof may be taken. The magnifying rate at which pixels of interpolations are generated is variable. In the above description, pixels of interpolations are generated in a rectangle with its vertical and horizontal edges enlarged three times the corresponding edges of the target pixel of interpolation. This magnifying rate may be changed to two times, four times, or other desirable rate.

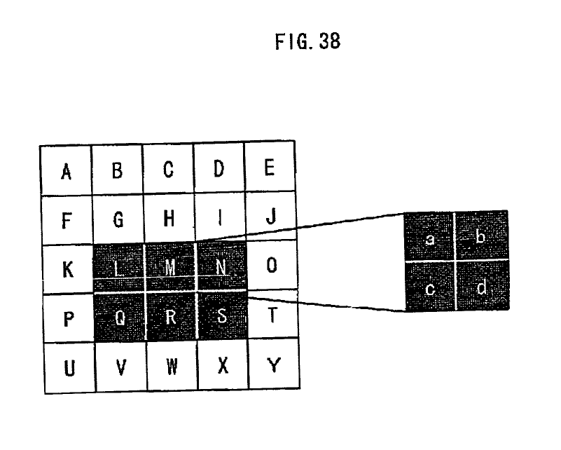

First, exemplary interpolation to which the magnifying rate of two times will now be explained. FIGS. 38 to 42 exemplifies such interpolation processing by which pixels a to d of interpolations are generated from the source pixel M. Refer to FIG. 38 where it is assumed that a horizontal edge has been found in the zone by pattern matching. Also for this example, if the luminance value of the target pixel M is greater (smaller) than that of the pixel R forming part of the edge, using the R pixel in addition to the M pixel for interpolation is not effective for highlighting and thus the target pixel shall be used as is. The more specific condition for making decision is:

((M=edge) & (R>M)) or ((M=not edge) & (R<M))

If this is fulfilled, highlighting is executed. The calculation formulas for this highlighting are:

a=b=M

c=d=M

Otherwise, highlighting is not executed and the following calculation formula is applied:

a=b=c=d=M

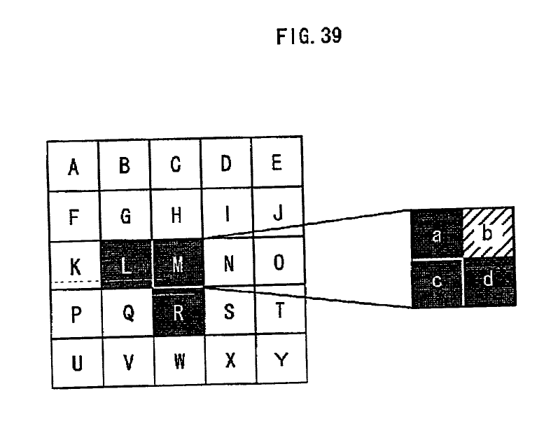

Then, refer to FIG. 39 where it is assumed that an angular edge has been found in the zone by pattern matching. The condition for making decision whether the detected edge is a right-angled edge is:

(((M=K=edge) & (F=not edge)) or ((M=W=edge ) & (X=not edge)))

or

(((M=K=not edge) & (F=edge)) or ((M=W=not edge) & (X=edge)))

If this is fulfilled, to highlight the light-angle feature of the edge, calculation for generating pixel b is executed, according to the following formula:

b=(L+R)/2

Otherwise, the above calculation is executed, according to the following formula:

b=(Gx2+Hx3+Nx3+Sx2)/10

For generating other pixels, the calculation formulas are:

a=(Lx3+Rx2)/5

c=(L+R)/2

d=(Lx2+Rx3)/5

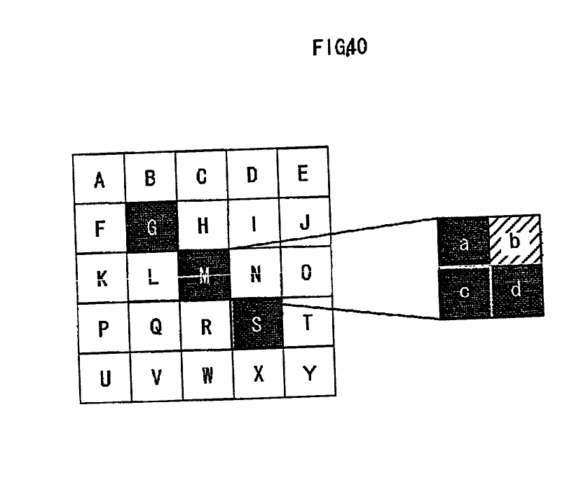

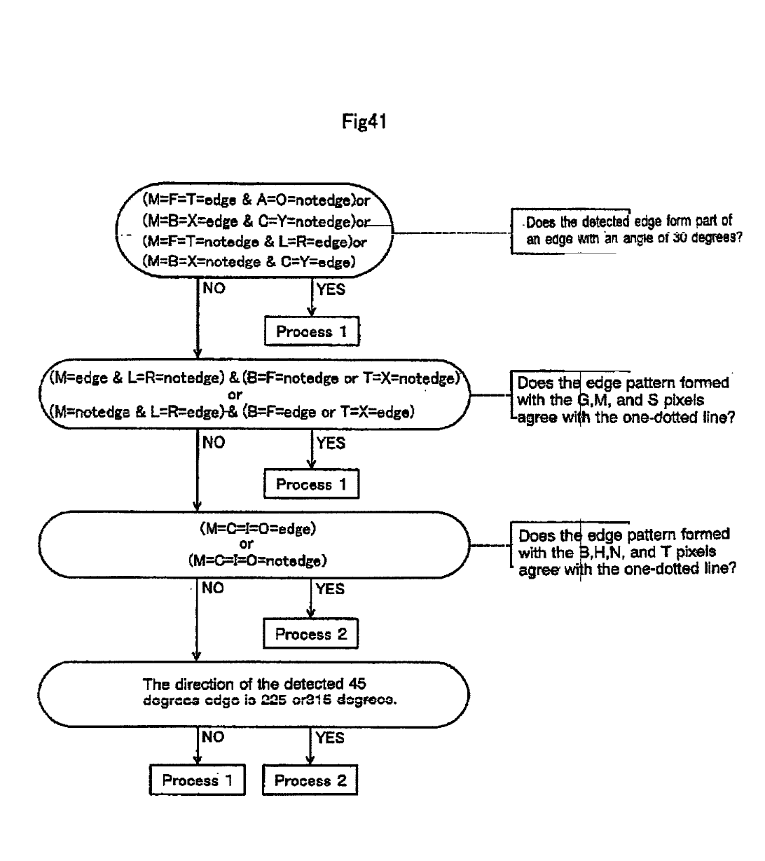

Refer to FIG. 40 where it is assumed that an edge with an angle of 45 degrees has been found in the zone by pattern matching. In order to decide whether the detected edge forms part of its extending edge with an angle of 45 degrees or an edge with an angle of 30 degrees, decision is made, subject to the conditions which are specified in FIG. 41, and the processing flow branches into two processes, depending on this decision and subsequent decisions. In FIG. 41, if process 1 is applied, the calculation formula to be used to generate pixel b is:

b=(G+S)/2

If process 2 is applied, the calculation formula to be used to generate pixel b is:

b=(H+N)/2

For generating other pixels, the calculation formulas are:

a=(Gx2+S)/3

c=(G+S)/2

d=(G+Sx2)/3

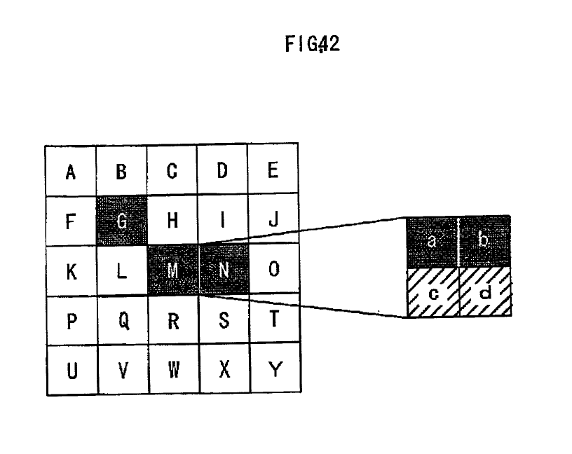

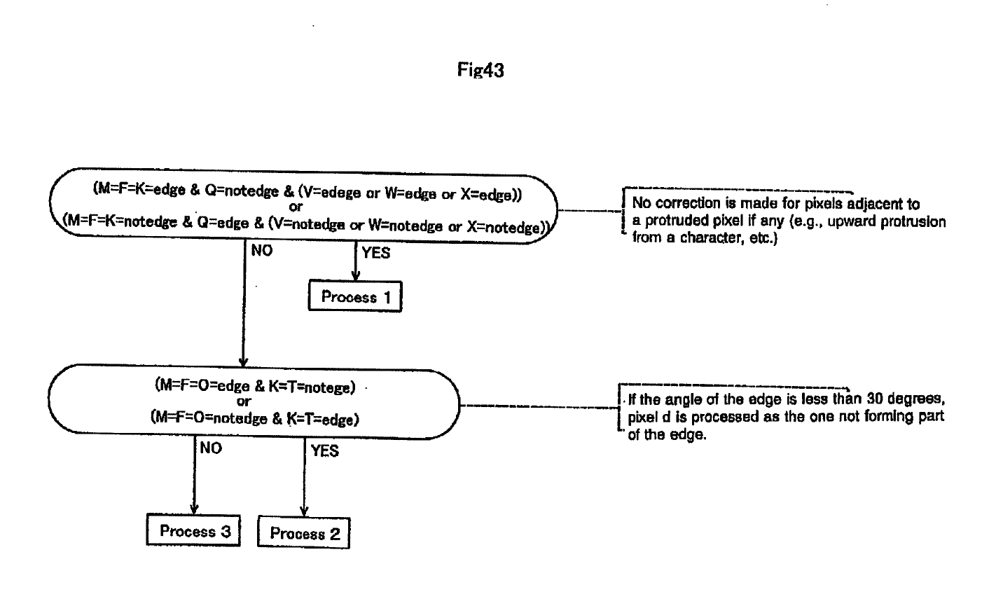

Refer to FIG. 42 where it is assumed that an edge with an angle of 30 degrees has been found in the zone by pattern matching. Depending on the decisions to be made subject to the conditions which are specified in FIG. 43, the processing flow branches into three processes. In FIG. 43, if process 1 is applied, the calculation formulas to be used to generate pixels c and d are:

c=(G+N)/2

d=(G+Nx2)/3

If process 2 is applied, the calculation formulas to by used to generate pixels c and d are:

c=(Lx3+Rx3+Sx2)/8

d=(Lx2+Rx3+Sx3)/8

If process 3 is applied, the calculation formulas to be used to generate pixels c and d are:

c=(Lx3+Rx3+Sx2)/8

d=(G+Nx2)/3

For generating other pixels, the calculation formulas are:

a=(Gx3+Nx2)/5

b=(Gx2+Nx3)/5

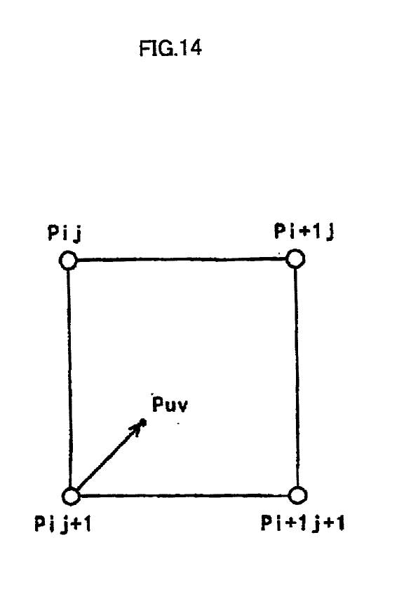

If the judgment is a mismatch between the above two-valued pattern of the reference 3×3 pixels and any of the prepared edge patterns of pixels formed in the above area comprising 3×3 pixels, the nearest method is executed instead of using the pattern matching method described above as the first interpolation processing. The concept of the nearest method is illustrated in FIG. 14 where the distance between each of four surrounding grid points Pij, Pi+lj, Pij+1, Pi+ij+1 and a desired point Puv to be interpolated is obtained and the data of the nearest grid point is given to the desired point as is. This can be expressed in a general equation as below:

Puv=Pij

where i=[u+0.5] and j=[v+0.5]. Brackets [ ] denote that Gauss' symbol integers are given.

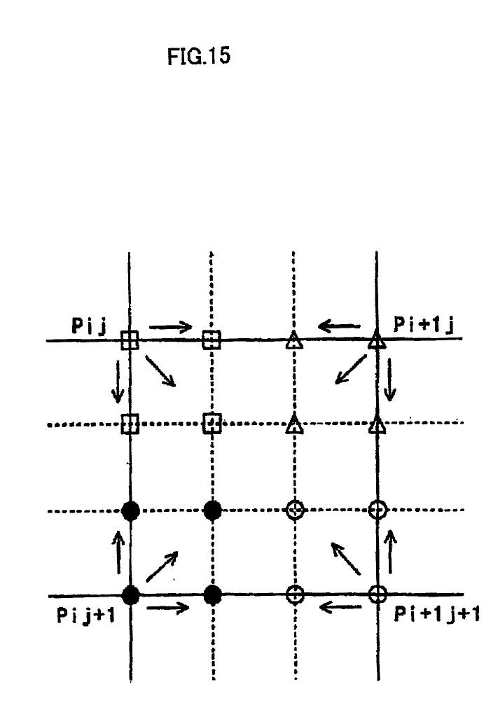

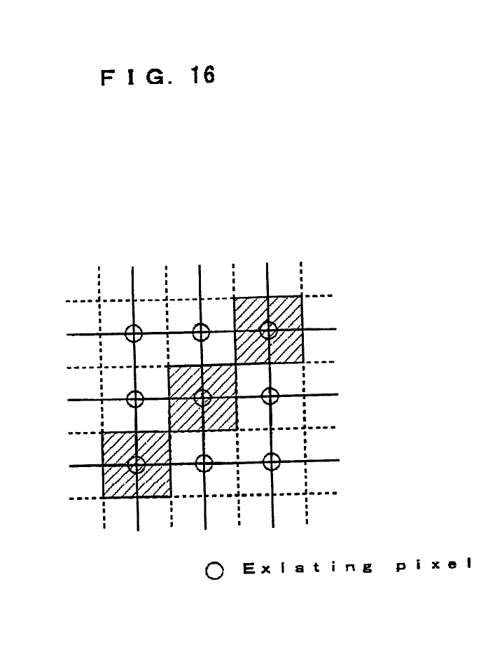

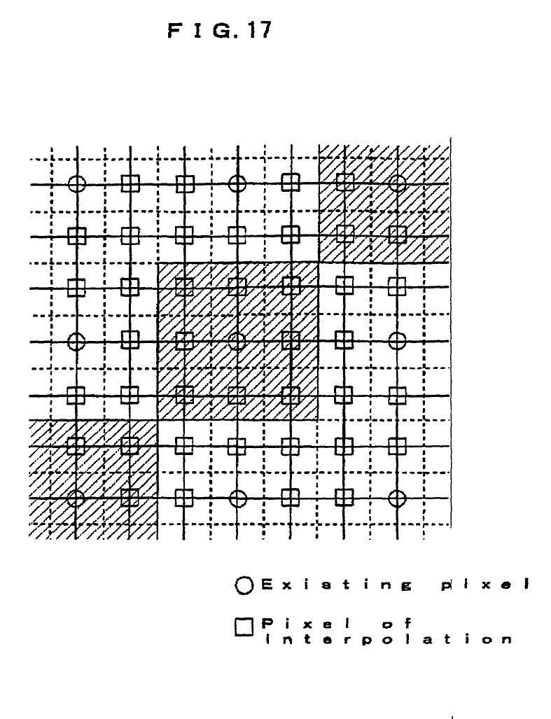

FIG. 15 shows pixels of interpolations increased three times the source in both vertical and horizontal directions by the nearest method. Before interpolation, it is assumed that there are four pixels (□Δ◯●) at the corners. When pixels of interpolations are generated, the nearest pixel data among the four pixels is given to them as is. That is, as regards this example, each of the four pixels at the corners is duplicated to pixels of interpolations adjacent to it. By this processing, an source image which is shown in FIG. 16 where black pixels are arranged diagonally against a background of white pixel changes to an image which is shown in FIG. 17 where black pixels are enlarged three times the source in both vertical and horizontal directions while they remain arranged diagonally. The nearest method has a feature of keeping the edges of an image as is. Thus, after the image is enlarged, its edges remains unchanged, though jaggy contours are found.

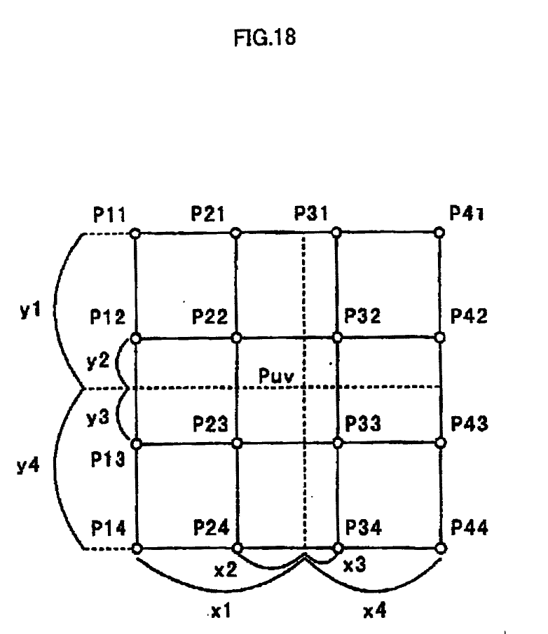

After pixels of interpolations are generated by the first interpolation processing in the manner described above, unless the above-mentioned rate is “1,” the second interpolation processing is further executed. In the present embodiment of the invention, interpolation by the cubic method is executed as the second interpolation processing, which will be described below. In the cubic method, as is shown in FIG. 18, not only four grid points surrounding a desired point Puv to be interpolated, but also outer grid points that further surround the four grid points, a total of 16 grid points are used.

When the 16 grid points surrounding the point Puv to be interpolated are given their tone values, the luminance of the point Puv is determined, subject to the influence of these tone values on the point Puv. For example, if interpolation is executed, based on a linear expression, the tone values of two grid points between which the point Puv exists are added with each point being given a weight in inverse proportion to its distance from the point Puv. When taking notice of the X axis direction, we express the distance of the above 16 grid points from the point Puv as follows: the distance to the outer left grid points is x1; the distance to the inner left grid points is x2; the distance to the inner right grid points is x3; and the distance to the outer right grid points is x4. We use function f (x) to express the degree of influence of the tone of the gird points on the luminance of the point Puv, according to the above distance. When taking notice of the Y axis direction, we express the distance of the above 16 grid points from the point Puv as follows: the distance to the top grid points is y1, the distance to the inner grid points above the point Puv is y2, the distance to the inner grid points below the point Puv is y3, and the distance to the bottom grid points is x4. Similarly, we use function f (y) to express the degree of influence of the tone of the gird points on the luminance of the point Puv, according to the above distance.

The 16 grid points act on the point Puv to be interpolated with the degree of their influence depending on their distance from the point Puv, which is expressed as described above. The degree of influence of the tone data of all grid points on the point Puv in the X and Y directions in the aggregate can be expressed in a general equation as below:

### Equation 2

$$P = [ f ( y1 ) f ( y2 ) f ( y3 ) f ( y4 ) ] [ \begin{matrix}P11 & P21 & P31 & P41 \\ P12 & P22 & P32 & P42 \\ P13 & P23 & P33 & P43 \\ P14 & P24 & P34 & P44\end{matrix} ] [ \begin{matrix}f ( x1 ) \\ f ( x2 ) \\ f ( x3 ) \\ f ( x4 )\end{matrix} ]$$

Hereupon, the degree of influence of the grid points on the point Puv depending on their distance can be expressed by a cubic convolution function as below:

f(t)={sin (πt)}/πt

Using the absolute values of the coordinates (u,v) of the point Puv, we can calculate the above distance values of x1 to x4 and y1 to y4 as follows:

x1=1+(u−|u|)y1=1+(v−|v|)

x2=(u−|u|)y2=(v−|v|)

x3=1−(u−|u|)y3=1−(v−|v|)

x4=2−(u−|u|)y4=2−(v−|v|)

On the above assumption, we develop P as follows:

### Equation 3

$$\begin{matrix}P = [ f ( y1 ) f ( y2 ) f ( y3 ) f ( y4 ) ] [ \begin{matrix}P11 \cdot f ( x1 ) + P21 \cdot f ( x2 ) + P31 \cdot f ( x3 ) + P41 \cdot f ( x4 ) \\ P12 \cdot f ( x1 ) + P22 \cdot f ( x2 ) + P32 \cdot f ( x3 ) + P42 \cdot f ( x4 ) \\ P13 \cdot f ( x1 ) + P23 \cdot f ( x2 ) + P33 \cdot f ( x3 ) + P43 \cdot f ( x4 ) \\ P14 \cdot f ( x1 ) + P24 \cdot f ( x2 ) + P34 \cdot f ( x3 ) + P44 \cdot f ( x4 )\end{matrix} ] \\ \begin{matrix}= f ( y1 ) \{ P11 \cdot f ( x1 ) + P21 \cdot f ( x2 ) + P31 \cdot f ( x3 ) + P41 \cdot f ( x4 ) \} + \\ f ( y2 ) \{ P12 \cdot f ( x1 ) + P22 \cdot f ( x2 ) + P32 \cdot f ( x3 ) + P42 \cdot f ( x4 ) \} + \\ f ( y3 ) \{ P13 \cdot f ( x1 ) + P23 \cdot f ( x2 ) + P33 \cdot f ( x3 ) + P43 \cdot f ( x4 ) \} + \\ f ( y4 ) \{ P14 \cdot f ( x1 ) + P24 \cdot f ( x2 ) + P34 \cdot f ( x3 ) + P44 \cdot f ( x4 ) \}\end{matrix} \\ \begin{matrix} = P11 \cdot f ( x1 ) \cdot f ( y1 ) + P21 \cdot f ( x2 ) \cdot f ( y1 ) + P31 \cdot f ( x3 ) \cdot f ( y1 ) + P41 \cdot f ( x4 ) \cdot f ( y1 ) + \\ P12 \cdot f ( x1 ) \cdot f ( y1 ) + P22 \cdot f ( x2 ) \cdot f ( y1 ) + P32 \cdot f ( x3 ) \cdot f ( y1 ) + P42 \cdot f ( x4 ) \cdot f ( y1 ) + \\ P13 \cdot f ( x1 ) \cdot f ( y1 ) + P23 \cdot f ( x2 ) \cdot f ( y1 ) + P33 \cdot f ( x3 ) \cdot f ( y1 ) + P43 \cdot f ( x4 ) \cdot f ( y1 ) + \\ P14 \cdot f ( x1 ) \cdot f ( y1 ) + P24 \cdot f ( x2 ) \cdot f ( y1 ) + P34 \cdot f ( x3 ) \cdot f ( y1 ) + P44 \cdot f ( x4 ) \cdot f ( y1 ) +\end{matrix}\end{matrix}$$

As is called the cubic convolution function, the function f (t) of the degree of influence of the grid points on the point Puv depending on their distance is approximated by the following cubic expression:

### Equation 4

$$\begin{matrix}f ( t ) = \{ sin ( xt ) \} / π t \\ \approx \{ \begin{matrix}1 - 2 \vert t \vert ** 2 + \vert t \vert ** 3 \cdot : & 0 ≦ \vert t \vert < 1 \\ 4 - 8 \vert t \vert + 5 \vert t \vert ** 2 - \vert t \vert ** 3 : & 1 ≦ \vert t \vert < 2 \\ 0 : & 2 ≦ \vert t \vert\end{matrix}\end{matrix}$$

This cubic method is characterized in that the tone gradually changes during the move from one grind point toward another, which is known as cubic functionally dependent change.

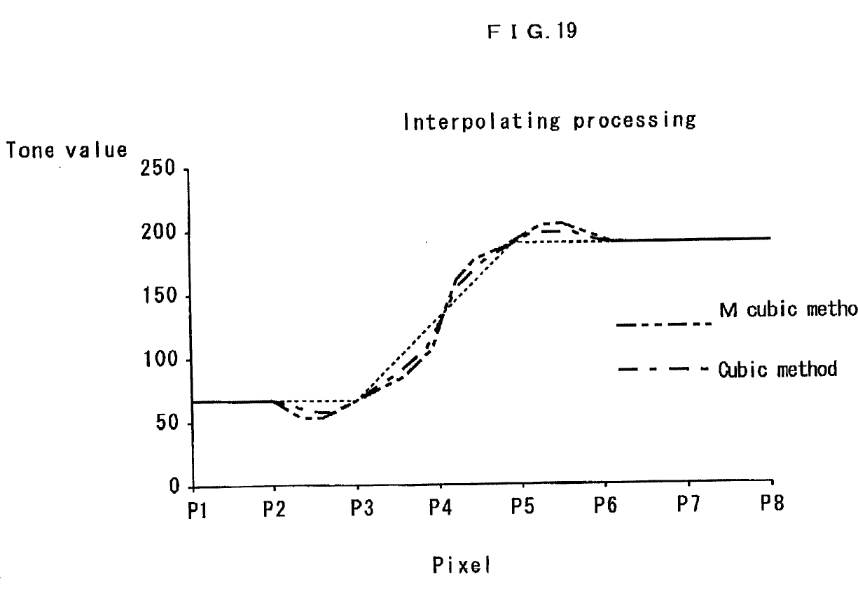

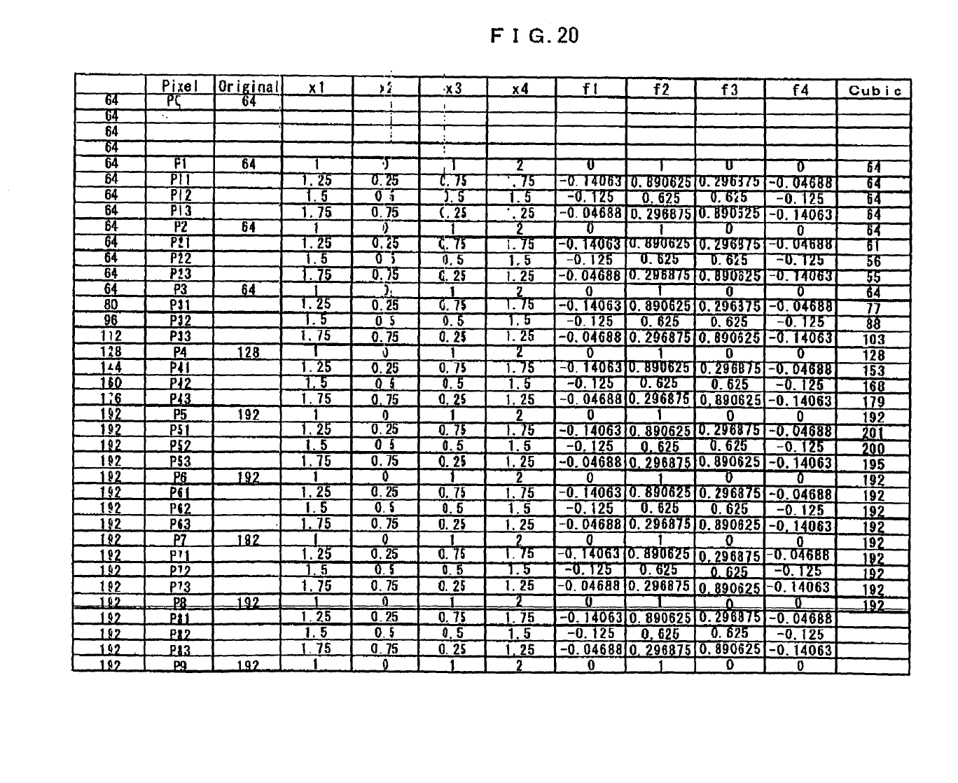

FIGS. 19 and 20 presents sample data on interpolation processing by the cubic method. For easy understanding, we use a model of pixels where a horizontally lengthening edge is formed, but no pixel data change occurs in the vertical direction to explain this interpolation processing. It is assumed that three pixels are interpolated.

Sample values listed in FIG. 20 are first explained. In the “Source” column at the left, the tone values of the pixels before interpolation are given. In this column, from the top to down, there are four pixels (P0, P1, P2, P3) with a tone value of “64”, one pixel (P4) with a tone value of “128, ” and five pixels (P5, P6, P7, P8, P9) with a tone value of “192”. The edge is part of the pixel with a tone value of “128.”

Three pixels (Pn1, Pn2, Pn3) are to be interpolated between the source pixels with distance between these pixels being “0.25.” The above distance values x1 to x4 for each point to be interpolated are given in the columns in the middle of the table. For the values of x1 to x4, functions f (x1) to f (x4) are separately calculated. When x1, x2, x3, and x4 are, for example, “1.25,” “0.25,” “0.75,” and “1.75,” respectively, the f (t) calculations for each are approximately “−0.14,” “0.89,” “0.30,” and “−0.05.” When x1, x2, x3, and x4 are “1.50,” “0.50,” “0.50,” and “1.50,” respectively, the f (t) calculations for each are approximately “−0.125,” “0.625,” “0.625,” and “−0.125.” When x1, x2, x3, and x4 are “1.75,” “0.75,” “0.25,” and “1.25,” respectively, the f (t) calculations for each are approximately “−0.05,” “0.30,” “0.89,” and “−0.14.” By using the above results, the tone values of the points to be interpolated are calculated. The results of calculation are given in the rightmost column of the table and plotted in a graph which is shown in FIG. 19. What is meant by this graph will be described in detail later.

As no pixel data change in the vertical direction is assumed, arithmetic is simplified. Only the pixel data of the four grid points (P1, P2, P3, P4) placed in the horizontal direction must be referred to. By using the function f (t) of the degree of influence of the grid points on a point to be interpolated, depending on their distance from that point, the cubic value (tone value) of the point to be interpolated can be calculated as follows:

P=P1·f(x1)+P21f(x2)+P3·f(x3)+P4·f(x4)

Hence, the cubic value (tone value) of point P21 to be interpolated is calculated as follows:

P21=64*f(1.25)+64*f(0.25)+64*f(0.75)+128*f(1.75

−64+(0.14063)|64⁺(0.890625)|64⁻(0.296875)|128*(−0.04688)=61

According to the cubic method, tone change is expressed cubic functionally and thus the quality of interpolation result can be adjusted by adjusting the obtained curve shape.

As examples of the adjustment, the following are given:

0<t<0.5 f(L)=−(8/7)L**3−(4/7)L**2+1

0.5<t<1f(t)=(1−t)(10/7)

1<t<1.5 f(t)=(8/7) (t−1)**3+(4/7)(t−1)**2−(t−1)

1.5<t<2f(t)=(3/7)(t−2)

Such adjustment is referred to as a hybrid-by-cubic method or an M (Modified) cubic method.

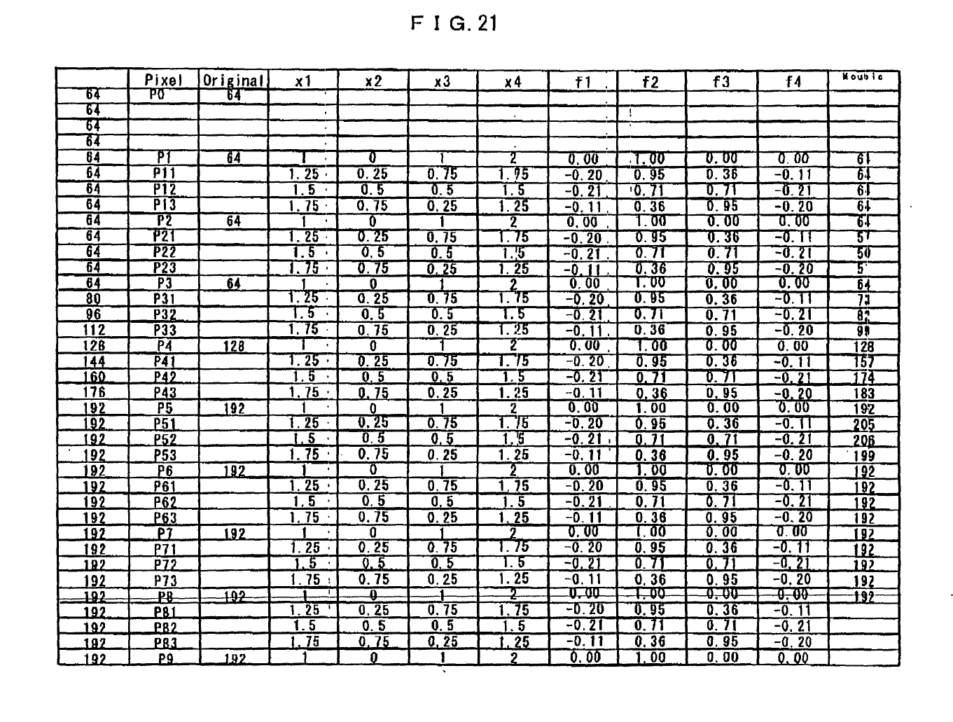

FIG. 21 presents sample data on interpolation processing by the M-cubic method, which lists the results of this interpolation for the model on the same assumption as for the cubic method. The result of interpolation processing by the M-cubic method is also shown in FIG. 19 where the cubic functional curve of the M-cubic example becomes slightly steeper than the curve of the normal cubic method, correspondingly making all parts of the image somewhat sharper. Whether the M-cubic method or the normal cubic method is used, once pixels of interpolations have been generated by the cubic method in the above step of the second interpolation processing, all parameters to be assigned to the above calculation equation for data to be blended are now obtained: i.e., data generated by the first interpolation processing, rate, and data generated by the second interpolation processing. By assigning these parameters to the above equation, calculation of the pixels of interpolations data to be blended at a ratio between the first and second interpolations is executed.

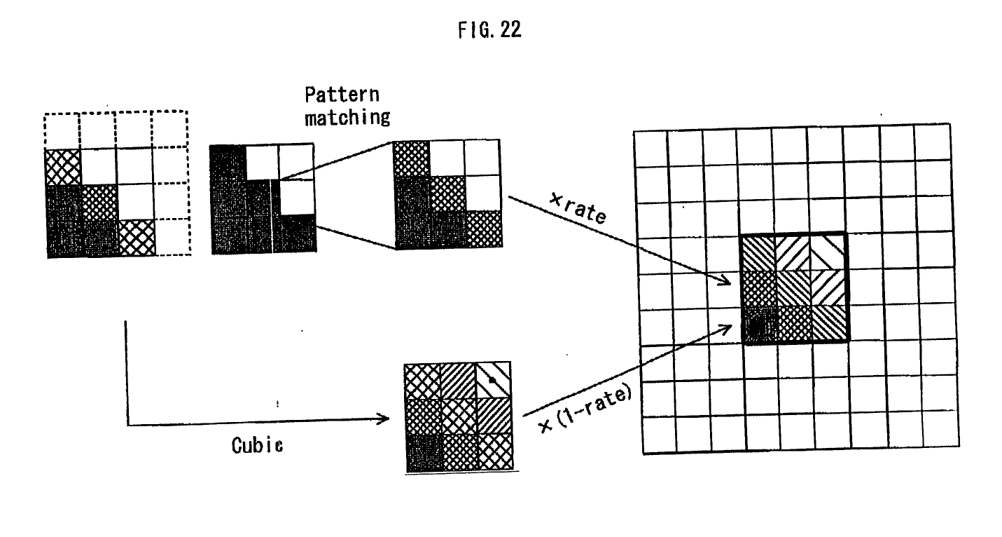

Using example image data which is shown in FIG. 22A, the data processing procedure up to the blending step will be explained below. Hereupon, it is assumed for this explanation that the number of discrete luminance values Y appearing in the zone comprising 5×5 pixels around the target pixel is greater than 15 and the above-mentioned rate is neither “0” nor “1.” Thus, after the rate is calculated in the step S108, the first interpolation is executed in the step S114. The zone (drawn with solid lines) comprising 3×3 pixels around the target pixel, shown in FIG. 22A, is extracted in the step S202 and a two-valued pattern of the pixels, which is shown in FIG. 22B, is created from the pixel data in that zone.

As this two-valued pattern of the pixels matches the corresponding given edge pattern prepared in advance, processing by the pattern matching method is executed in the step S208 and pixels of interpolations which are shown in FIG. 22C are generated. By this processing, from the 3×3 pixels shown in FIG. 22A where an edge appears in the diagonal direction with the luminance gradient toward the left bottom, pixels of interpolations shown in FIG. 22C are generated where the property of the 3×3 pixels is reflected; i.e. the edge in the diagonal direction remains as is and the luminance gradient toward the left bottom highlights the edge.

On the other hand, in the step S118, from the pixel data shown in FIG. 22A, pixels of interpolations which are shown in FIG. 22D are generated. Hereupon, to generate a pixel of interpolation, data of 16 pixels surrounding the pixel is used. For example, to generate a right top pixel with a black dot, shown in FIG. 22D, 16 pixels in the zone drawn with solid and dotted lines shown in FIG. 22A, are used. In the thus generated pixels of interpolations, subtle tone difference between the pixels in the above zone drawn with the solid and dotted lines is reflected due to the characteristics of the cubic method, while the edge is made vague as contrasted with the edge made by the above pattern matching method. That is, the edge appears in the diagonal direction of the rectangle comprising the pixels of interpolations, but the luminance gradient toward the left bottom becomes moderate and this makes the edge vague.

After the pixels of interpolations are generated by the first and second interpolation processing, the pixels of interpolations generated by the first interpolation processing are multiplied by rate and the those generated by the second interpolation processing are multiplied by (1−rate) In this way, blended pixels of first and second interpolations, which are shown in FIG. 22E, are generated. Once the blended pixels of first and second interpolations to the target pixel, as shown in FIG. 22E, have been generated, the judgment in the step S122 is made. As long as another target pixel of interpolation exists in other coordinates, the interpolation procedure is repeated. When all target pixels have been processed, the interpolation-processed image data is transferred to the next process in the step S124. However, depending on the magnifying rate of interpolations, the amount of the interpolation-processed image data may become quite huge. There may be hardware limitation; i.e., the available memory area for the printer driver 12c is not so much. In this case, the above data may be output in blocks of a given amount.

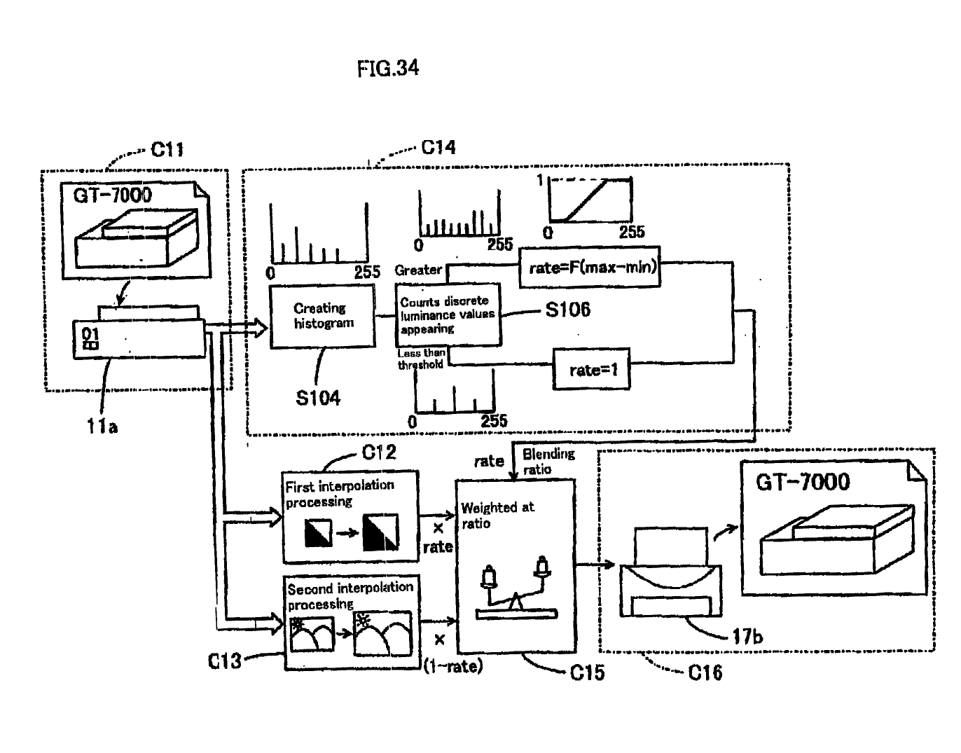

Finally, a general view of the present embodiment of the invention is shown in FIG. 34. The scanner 11a scans a photograph and generates digitized source image data that is processed in the following processes. The unit to acquire this source image data is the image data acquisition unit C11.

In the step S104, the source image data is read and a histogram of luminance values in the zone comprising 5×5 pixels around a target pixel is created. In the step S106, the number of discrete luminance values appearing in the created histogram is counted. If this count is less than a predetermined threshold, the attribute of the image is simply regarded as a non-natural picture and the blending ratio (rate) of interpolations by the first interpolation processing to those by the second interpolation processing is set to 1. If the count is greater than the threshold, the attribute of the image is regarded as a natural picture or a mixed image of natural and non-natural pictures and the rate is determined by the evaluation function F. This evaluation function F is a function of difference between the maximum luminance value Ymax and the minimum luminance value Ymin in the above zone and sets the rate by evaluating edge-like visualization. The unit to obtain a blending ratio between the first and second interpolations in this way is the first unit of determining a blending ratio C14.

In the step S114, interpolation processing is executed within the predetermined zone around the target pixel by the pattern matching method or the nearest method. The interpolation that tends to keep the edge intact is carried out by the first interpolation processing unit C12.

On the other hand, in the step S118, interpolation processing is executed by the cubic method in which subtle tone difference between the pixels is reflected, while the edge is made vague, as contrasted with the edge made by the pattern matching method. This interpolation is carried out by the second interpolation processing unit C13.

Then, in the step S120, the data of pixels separately interpolated by the first and second interpolations are weighted and added by the equation (1) to which the blending ratio (rate) determined as described above is assigned and blended pixels of first and second interpolations are generated. The total sum of the blending ratio, of course, becomes “1.” This step is carried out by the image data blending unit C15.

Following that, the above procedure is repeated with the target pixel being changed until all target pixels have been processed. Then, an interpolation-processed image is created. Thus, completely interpolation-processed image data is output in the step S124. This step is carried out by the image data output unit C16. By way of example, if the image is output to the printer 17b, its print will be produced.

Next, another preferred embodiment of the present invention will be described below. In this second embodiment, a printing system uses the image data interpolation program. Components used in common with the forgoing first embodiment are referred to as in the foregoing description.

To the above-mentioned printer 17b, the result of processing of the application 12d is output through the printer driver 12c as print data. The color printer 17b prints the image from the data by printing the dots of the image on printing paper with color inks.

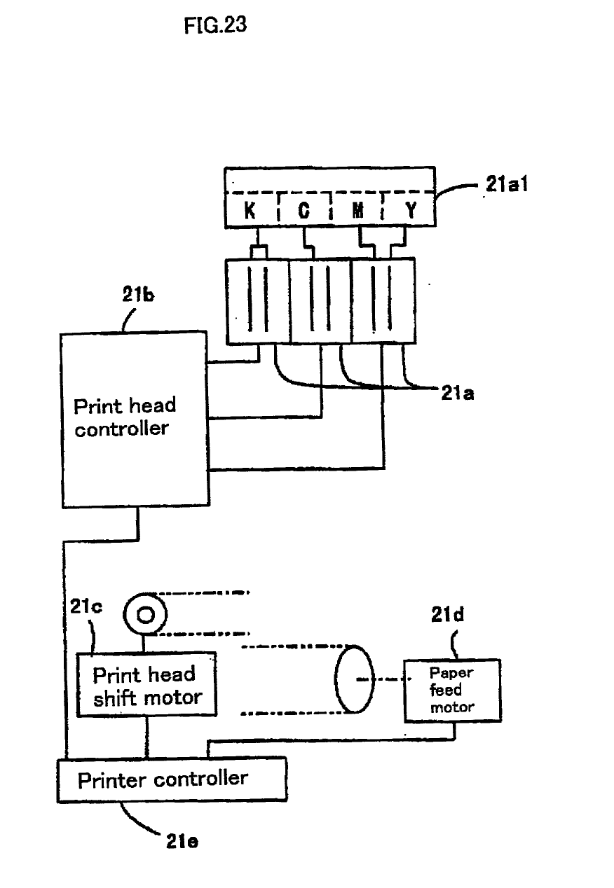

The outline structure of a color ink jet printer 21 as an example of the color printer is shown in FIGS. 23 to 25. The color ink jet printer 21 is equipped with a dot printing mechanism consisting of a print head 21a comprising three print head units, a print head controller 21b that controls the print head 21a, a print head shift motor 21c for moving the print head 21a in the shift direction, a paper feed motor 21d for feeding printing paper in the line feed direction, and a printer controller 21e for interfacing these print head controller 21b, print head shift motor 21c, and paper feed motor 21d with external equipment. The color ink jet printer 21 can print an image while scanning the print head 21a on an image recording medium which is printing paper, according to the print data.

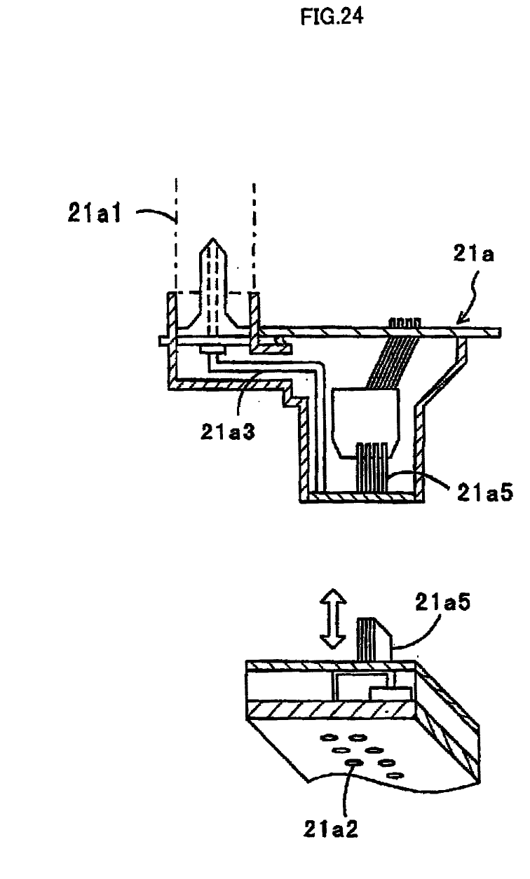

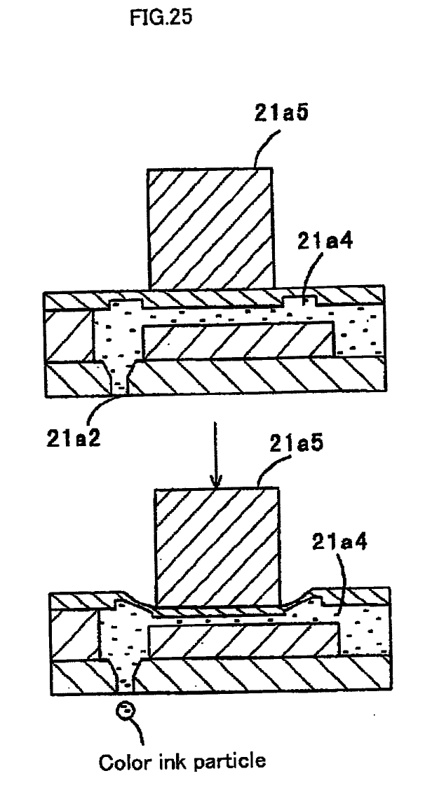

FIG. 24 shows the internal structure of the print head 21a. FIG. 25 illustrates the ink jet mechanism. Inside the print head 21a, a narrow pipe line 21a3 from a color ink tank 21a1 to nozzles 21a2 is formed and terminates at a section where an ink chamber 21a4 is formed. The walls of the ink camber 21a4 are made of flexible material and are furnished with a piezo element 21a5 that is an electostriction device. When voltage is applied to the piezo element 21a5, its crystal structure is distorted and the element performs rapid electrical-to-mechanical energy conversion. By the distortion of the crystal structure, the wall of the ink chamber 21a4 is pushed and the capacity of the chamber 21a4 decreases. Then, a given amount of color ink particles are jetted out of the nozzles 21a2 provided at the bottom of the ink chamber 21a4 This pump structure is referred to as a micro-pump mechanism.

On one print head unit, two independent rows of nozzles 21a2 are formed so that particular color ink will be supplied to each row of nozzles 21a2. Thus, three print head units each have two rows of nozzles and a maximum of six color inks can be used. In the printer example shown in FIG. 23, it is assumed that color inks are used in the following manner: a black ink is supplied to two rows of nozzles of the left print head unit, a cyan ink is supplied to only one row of nozzles of the middle print head unit, and a magenta ink and a yellow ink are separately supplied to two right and left rows of nozzles of the right print head unit.

Spacing of the nozzles 21a2 in the row lengthwise direction, formed on the bottom surface of the print head 21a, does not agree with the resolution of printing. In general, this spacing of the nozzles 21a2 is larger than the resolution of printing. Notwithstanding, the printer is able to print at high resolution because the paper feed motor 21d is controlled to appropriately feed paper in the line feed direction. For example, if paper is fed in eight steps over the distance of the spacing of the nozzles 21a2 and the print head 21a is moved in the shift direction for each step, the printing resolution increases. In the shift direction, because jetting color ink at arbitrary intervals determines resolution, it can be said that resolution depends on timing control. Exactly speaking, the dot diameter of color ink is also considered as a factor in determining resolution, but this is ignored for easy understanding convenience.

In the second embodiment of the invention, it is assumed that the invention is embodied on the above-mentioned hardware system and printing is executed, based on the image data acquired by the image input device of the computer system 10. If there is difference between the resolution of the source image data and the resolution of the color printer 17b, interpolation processing is executed. The following will explain internal operation flow: after the application 12d starts to execute print processing, change is made to the resolution and tone of the image data and the print data that reflects this change is output to the color printer 17b.

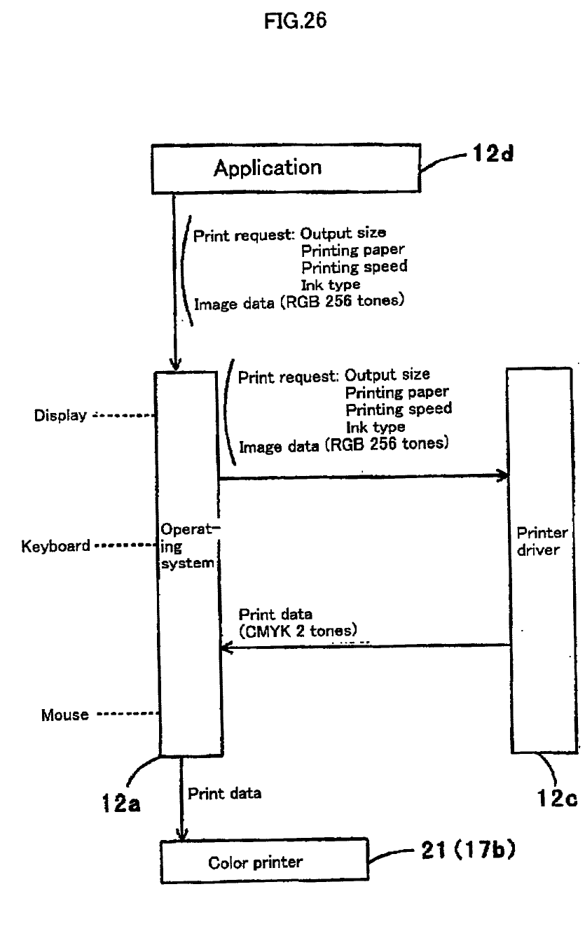

FIG. 26 illustrates the flow of image data. The application 12d issues a print request to the operating system 12a, when the application passes the parameters of output size, printing paper, print speed, and ink type, as well as image data in RGB 256 tones to the operating system. Then, the operating system 12a passes these parameters and the image data to the printer driver 12c. At the same time, the operating system 12a displays the image on the display 17a by means of the display driver 12b and transfers the result of user operation via the keyboard 15a and the mouse 15b to the printer driver 12c. The printer driver 12c executes image interpolation processing so that the specified output size will be obtained, and generates print data. This print data, which is usually in CMYK two tones, is output to the color printer 17b from the hardware port under the control of the operating system 12a.

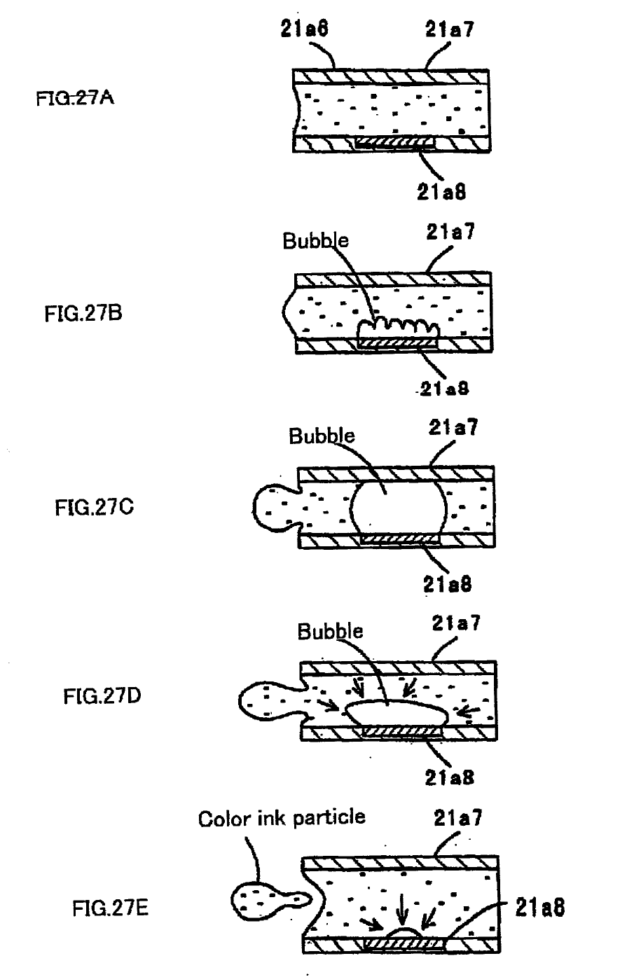

In the second embodiment, the print control program is executed on the computer system 10 in this way and the print data is output to the color printer 17b. However, the applicable printer is not limited to the above color printer 21 of ink jet type. Although this color printer is, for example, an ink jet type that uses micro-pump mechanism, other mechanisms can be used. A pump mechanism of bubble jet type is put into practical use, as is shown in FIG. 27, where the wall of a pipe line 21a7 is furnished with a heater 21a8 near the nozzle 21a6. As the color ink is heated by the heater 21a8, a bubble is generated and eventually the color ink is jetted out by the pressure of the bubble.

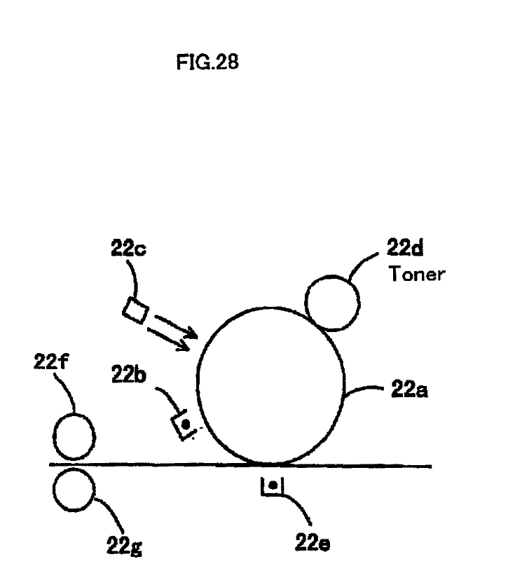

Furthermore, FIG. 28 shows the outline structure of the primary part of what is called an electrophotographic color printer 22 as another mechanism. Along the circumference of a rotary drum 22a as a photosensitive body, a charger unit 22b, an exposure unit 22c, a developer unit 22d, and a transfer unit 22e are arranged in position in harmony with the direction of rotation. After the charger unit 22b uniformly charge the surface of the circumference of the rotary drum 22a, the exposure unit 22c discharges the drum surface where an image is captured, the developer unit 22d makes toner cling to only the discharged surface of the drum, and the transfer unit 22e transfers the toner onto paper as an image recording medium. Then, as paper passes between a heater 22f and a roller 22g, the toner is fused and fixated onto the paper. Because a set of these units carries out printing by using one color toner, four sets for all four colors are provided

In short, there is no particular limitation on the practical structure of the printer. Not only the application range of particular printing methods as described above but also the application manner may be varied.

Next, procedure in which optimum image processing is executed by using the above printing system, according to the output resolution, will be explained below.

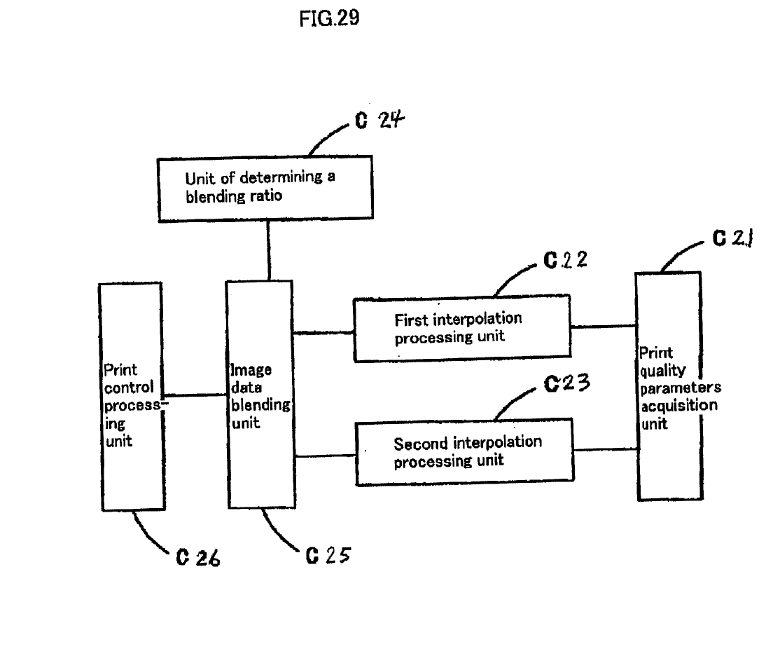

FIG. 29 is a block diagram showing the outline configuration of this printing system. A print quality parameters acquisition unit C21 acquires print quality parameters, according to which the input image is printed in the activated print job. A first interpolation processing unit C22 and a second interpolation processing unit C23 perform interpolation processing by which the number of pixels constituting the image data multiplies. The first interpolation processing unit C12 is able to execute the pattern matching method and the nearest method as interpolation processing. The second interpolation processing unit C13 is able to execute the cubic method as interpolation processing.

A second unit of determining a blending ratio C24 determines a blending ratio between the pixels interpolated by the first interpolation processing unit C12 and those interpolated by the second interpolation processing unit C13, based on the print quality parameters acquired by the above print quality parameters acquisition unit C21. Once the second unit of determining a blending ratio C24 have determined a blending ratio, an image data blending unit C25 blends the data of the pixels interpolated by the first interpolation processing unit C22 and the data of the pixels interpolated by the second interpolation processing unit C23 at that blending ratio. Then, an image data output unit C26 generates printing data and executes printing, based on the pixels data blended by the image data blending unit C25.

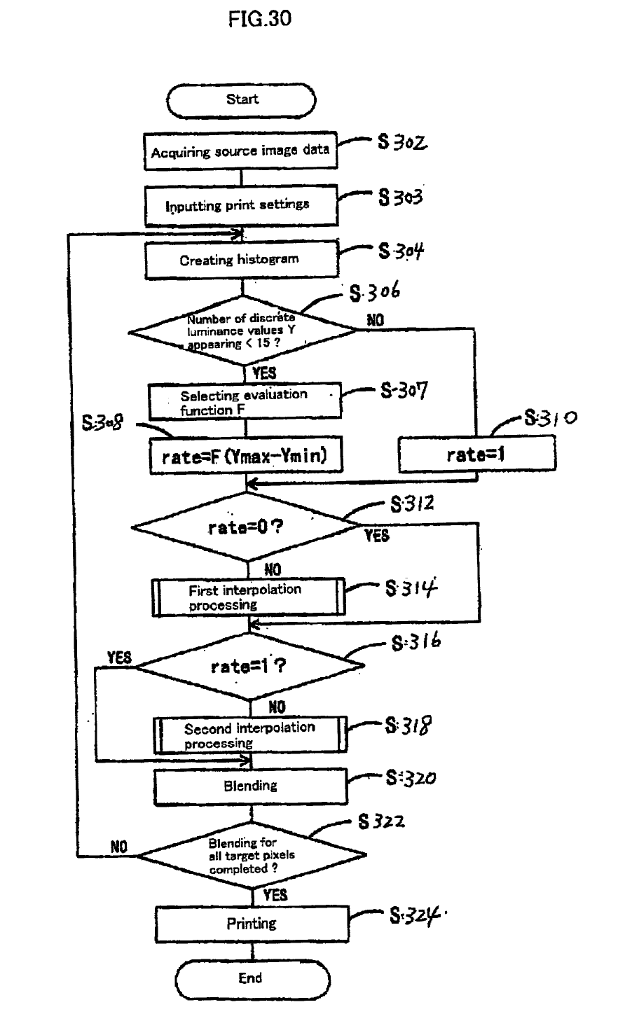

FIG. 30 is a flowchart illustrating the software operation flow regarding the print processing that the above printer driver 12c executes. In FIG. 30, source image data is acquired in step S302. For example, during process sequence in which an image is scanned by the scanner 11a under the control of the application 12d, the image data is processed by predetermined image processing, and printing from the image data is executed, image data of predetermined resolution is passed via the operating system 12a to the printer driver 12c and this stage corresponds to the step S302.

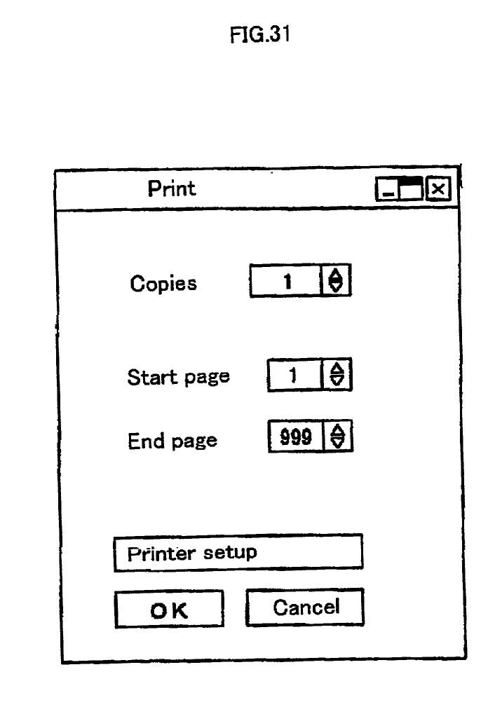

In step 303, print parameter settings are input. When the application 12d starts to execute print processing, if it is assumed that the operation system 12a provides the GUI environment, a print operation window like the one which is shown in FIG. 31 is displayed. Although parameters to be input on this window may be varied, those in the present embodiment are “Copies (of prints),” “Start Page,” and “End Page.” As operation command buttons, the “OK” button, the “Cancel” button, and the “Printer Setup” button are provided.

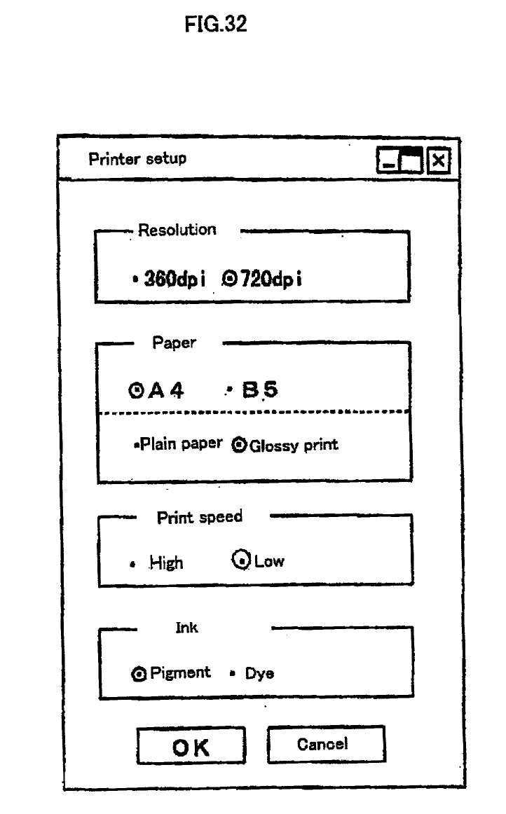

When you choose the “Printer Setup” button, a window like the one which is shown in FIG. 32 is displayed. This window is provided to allow the user to set print parameters which are varied, depending on the printer-specific capability. As will be described later, depending on the settings specified on this window, a blending ratio changes. In the present embodiment, the user can select either “360 dpi” or “720 dpi” as “Resolution (of print).” Furthermore, the user may select “A4” or “B5” size and “Plain Paper” or “Glossy Print” quality as “Paper,” “High” or “Low” as “Print Speed.” and “Pigment” or “Dye” as “Ink.” Of course, these print setting parameters are examples. It is not necessary that the printer setup window be embodied to allow the user to select all these parameters. This window can be embodied in various ways, for example, it can be designed such that the user can specify an ink type through bidirectional communication with the above color printer 17b.

In the present embodiment, the settings of the above parameters are stored into a setup file under the management of the operating system 12a. If these parameters have previously been set, the setup file is referred to and read. If the operator changes the settings for print operation, the updated settings are read as the set print parameters. The processing of this step S303 is regarded as the step or function of print quality parameters acquisition from the software point of view. However, it can be understood that the description of all steps including this step of print quality parameters acquisition to be executed by the computer does not directly include the operation of the operating system 12a itself and hardware. On the other hand, if this step is considered to be implemented as part of the organically integrated operation of the hardware including the CPU, it corresponds to the action of the print quality parameters acquisition unit C21.

In step S304, a pixel in the read image data is set as a target of interpolation, the pixel data in a zone comprising 5×5 pixels around the target pixel is set to be reference pixels, and a histogram of the luminance values of the reference pixels is created. In step S306, the number of discrete luminance values appearing in the created histogram is counted and judgment is made as to whether this count is less than 15. The greater the number of discrete luminance values, the greater will be the number of colors assigned to the reference pixels. From this fact, if the number of discrete luminance values appearing in the histogram is less than 15, the reference pixels are regarded as the pixels belonging to a non-natural picture. When the judgment is the above step S306 is that the number of discrete luminance values appearing is less than 15, a blending ratio (rate) of interpolations by the above first interpolation processing to those by the second interpolation processing is set to 1 in step 310.

When the judgment in the step S306 is that the number of discrete luminance values appearing is not less than 15, an evaluation function F is selected in step 307, based on the settings of the print parameters input in the above step S303. In the step 307, if high print quality is set, an evaluation function F is selected that gives a high blending ratio of the pixels interpolated by the second interpolation processing to those interpolated by the first interpolation. In the present embodiment, two types of evaluation functions are prepared: one for high print quality and the other for low print quality. The detail thereof will be described later. The value of the evaluation function for high print quality is smaller than the value of the evaluation function for low print quality. This evaluation function F is a function of the width of the range within which the luminance values of the above reference pixels fall, that is, the difference between the maximum luminance value Ymax and the minimum luminance value Ymin among the reference pixels.

In step S308, to the evaluation function F selected in the above step S307, the difference between the maximum luminance value Ymax and the minimum luminance value Ymin based on the above histogram is assigned and the rate is determined. Thus, the sequence of the steps S304, S306, S307, S308, and S310 corresponds to the second step or function of determining a blending ratio. If these steps are considered to be implemented as part of the organically integrated operation of the hardware including the CPU, they are defined as the action of the second unit of determining a blending ratio C24.

After the rate is determined in the step S308 or the step S310, judgment is made as to whether the rate is “0” in step S312. When the rate is “0,” the first interpolation processing is not executed. When the judgment in the step S312 is that the rate is other than “0,” the first interpolation processing is executed in step S314. Thus, this step corresponds to the step or function of first interpolation processing. If this step is considered to be implemented as part of the organically integrated operation of the hardware including the CPU, it is defined as the action of the first interpolation processing unit C22.

Then, in step S316, judgement is made as to whether the rate is “1.” When the rate is “1,” the second interpolation processing is not executed. When the judgment in the step S316 is that the rate is not “1,” the second interpolation processing is executed in step S318. Thus, this step corresponds to the step or function of second interpolation processing. If this step is considered to be implemented as part of the organically integrated operation of the hardware including the CPU, it is defined as the action of the second interpolation processing unit C23. After the rate is determined in this way and the first and/or second interpolation processing is executed, in step S320, blending of pixel data of interpolations is performed, according to the following equation, where the set rate shall be assigned, and then pixels of interpolations are generated in step S320.

Data to be blended=(First interpolation)×rate+(Second interpolation)×(1−rate) (1)

Thus, this step corresponds to the step or function of image data blending. If this step is considered to be implemented as part of the organically integrated operation of the hardware including the CPU, it is defined as the action of the image data blending unit C25. Upon the completion of the above sequence of generating data of interpolations to the target pixel, judgment is made as to whether blending of interpolated data has been completed for all target pixels in the input source image data in step S322. If not, the step S304 and subsequent steps are repeated until blending of interpolated data has been completed for all target pixels.

Upon the completion of blending of interpolated data for all target pixels, printing is executed, based on the interpolation-processed image data, in step S324. For the printer driver 12c, print data is not obtained only by resolution conversion; color conversion and halftone processing are further required. Thus, such conversion and processing are executed and the resultant print data is output to the color printer 17b. The processing of this step corresponds to the step or function of print control processing. If this step is considered to be implemented as part of the organically integrated operation of the hardware including the CPU, it is defined as the action of the print control processing unit C26.

Then, detailed processing for each step in the above flowchart will be explained below. In the present embodiment, judgment is made as to whether the source image acquired in the step S302 belongs to computer graphics (non-natural pictures) or photography (natural pictures) and the result of the judgment as well as the print quality parameters are reflected in setting a blending ratio between the first and second interpolations. To prevent incorrect selection of an interpolation method to be applied, it is, of course, possible to avoid fixing the above-mentioned rate to “1” or “0.” However, in the present embodiment, if the number of discrete luminance values appearing in the reference pixels is less than 15, the pixels are regarded as those belonging to a non-natural picture. This is because the inventor considers it more important to avoid the application of the second interpolation processing to non-natural pictures; otherwise, the second interpolation would make contours vague in a non-natural picture.

For the above judgment, a histogram of luminance values, which is shown in FIG. 14, is used. In the step 104, the luminance values of the reference pixels in the zone comprising 5×5 pixels are obtained and a histogram is created to show how the pixels are distributed in the range of their luminance values. The number of discrete luminance values appearing in the histogram, that is, how many luminance values appear for which the number of distributed pixels is other than “0” is counted, based on which, the judgment in the step S306 is made.

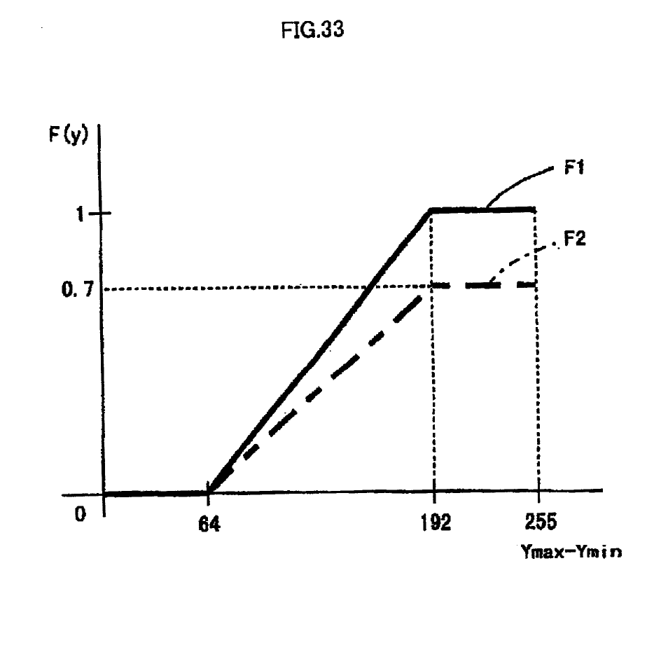

In the histogram of luminance values, if there are 15 or more luminance values for which the number of distributed pixels is other than “0,” the blending ratio of the pixels interpolated by the above first interpolation processing to those interpolated by the second one is determined by the appropriate evaluation function. In the present embodiment, two evaluation functions are prepared beforehand: one for high print quality and the other for low print quality. If any one of the print parameters set on the window shown in FIG. 32 indicates high print quality, the evaluation function for high print quality is selected to be used in the step S306. FIG. 33 gives examples of evaluation functions F (y): F1 is the evaluation function for low print quality and F2 is the evaluation function for high print quality.

For the evaluation function F1 (y), the value of “y” falls within the range that 0≦y≦255 and varies in the range that 0≦1(y)≦1. F (y) is 0 in the range that 0≦y≦64 and 1 in the range that 192≦y≦255. F (y) linearly increases from 0 to 1 in the range that 64≦y≦192. For the evaluation function F2 (y), the value of “y” falls within the range that 023 y≦255 and varies in the range that 0≦F (y)≦0.7. F (y) is 0 in the range that 0≦y≦64 and 0.7 in the range that 192≦y≦255. F (y) linearly increases from 0 to 0.7 in the range that 64≦y≦192.

Hereupon, the width of the range within which the luminance values falls, “Ymax-Ymin,” shown in FIG. 14, is assigned to “y.” Thus, the greater this width value, that is, the reference pixels make edge-like visualization due to mutual relation in luminance, the greater will be the rate. Even at the same width value, the value of the evaluation function F1 is always greater than the value of the evaluation function F2. This means that, for high print quality, even at the same width value, the blending ratio of the pixels interpolated by the second interpolation processing by which interpolation is executed without affecting the gradation of the tones to the pixels interpolated by the first interpolation becomes greater.

When “high resolution of print,” “high printing paper quality,” and/or “low print speed” are selected, that is, printing for high print quality is executed, by executing the interpolation not affecting the gradation of the tones of the source image, subtle tone gradation is reproduced as the effect visible to the user on the image produced by printing. On the other hand, when printing for low print quality is executed, even if print data from which subtle tone gradation is reproducible is used for printing, such gradation is not reproduced as the effect visible to the user on the image produced by printing. Thus, it can be said that the second interpolation processing is worthy of being executed when high print quality is desirable. In the present embodiment, by using the evaluation function F2, the blending ratio of the pixels interpolated by the second interpolation processing to those interpolated by the first one is set high.

In the present embodiment, the ink type selection also influences the selection between the above evaluation functions. Selection can be made between “pigment” and “dye” as ink type; which is of high quality cannot be determined easily. However, due to its property, pigment ink does not easily blur as compared with dye and tends to highlight the edge contrast on the image produced by printing. Thus, it can be said that ink type selection reflects print quality. In the present embodiment, to obtain same level print result by using either of both ink types, the blending ratio of the pixels interpolated by the second interpolation processing to those interpolated by the first one should be higher for “pigment” than as for “dye.” In the present embodiment, the above evaluation function F2 shall be used when the ink selection is “pigment.”

Of course, the manner of reflecting the evaluation functions and the settings the above print parameters acquired in interpolation in the present embodiment has been described above for illustrative purposes; a variety of manners thereof can be taken. For example, a plurality of evaluation functions can be prepared and they are not necessarily two types as described above. If there are four discrete print parameters to be set, influencing the print quality, as in the above embodiment, four evaluation functions may be prepared. It is conceivable that each time high quality setting increases by one, another evaluation function with the maximum value being lower should be selected.

In another manner, it is not necessary to prepare a plurality of evaluation functions beforehand, but only the above-mentioned evaluation function F1 should be prepared. This function can be used in the following way. When high quality printing is desirable, the value of the evaluation function is multiplied by “0.7” and the rate is determined. Each time high quality setting increases by one, the value of the evaluation function may be multiplied by “0.9.” Furthermore, it is not necessary to restrict the evaluation function curves to their examples shown in FIG. 33. Any function may be used that shows the characteristic: when the width of the range of the luminance values is assumed variable, the function value increases monotonously as the value of the width increases. Alternatively, an evaluation function whose value gradually changes over the range of luminance values of 0 to 255 may be used.

Once the evaluation function to be used have been determined in the way described above in the step S307, a blending ratio, the rate is determined by using the evaluation function in step S308. In the histogram shown in FIG. 14, because there are 19 luminance values for which the number of distributed pixels is other than “0,” after the affirmative judgment is made in the step S306, the processing of the step S307 is executed. When resolution of “720 dpi,” “glossy print” paper, “high” print speed, and “pigment” ink are selected as shown in FIG. 32, the settings of the print parameters of resolution, paper, and ink require the selection of the evaluation function for high quality printing and thus the evaluation function F2 is selected in the step S307. Then, the rate is determined by the evaluation function F2 in the step S308 and the first interpolation processing in the step S314 and the second interpolation processing in the step S318 are executed.

After pixels of interpolates are generated by the first interpolation processing, if the above rate is not “1,” the second interpolation processing is further executed. Whether the M-cubic method or the normal cubic method is used, once pixels of interpolations have been generated by the cubic method in the above step of the second interpolation processing, all parameters to be assigned to the above calculation equation (1) for data to be blended are now obtained: i.e., data generated by the first interpolation processing, rate, and data generated by the second interpolation processing. By assigning these parameters to the equation (1), calculation of the pixels of interpolations data to be blended at a ratio between the first and second interpolations is executed.

Hereupon, according to the settings shown in FIG. 32, high print quality is set and subtle tone gradation can be reflected in the print result in this state. At this time, because the evaluation function is F2, the blending ratio of the pixels interpolated by cubic method to those interpolated by the first interpolation is set high.

On the other hand, if resolution of “360 dpi,” “plain” paper, “high” print speed, and “dye” ink are selected on the window shown in FIG. 32, low print quality is set and the effect of the second interpolation processing is not noticeable. In this state, the above-mentioned evaluation function F1 should be used and the blending ratio of the pixels interpolated by the second interpolation processing to those interpolated by the first interpolation should be set lower in contrast with the above state of the settings shown in FIG. 32. At this time, higher is the blending ratio of the pixels interpolated by pattern matching method or nearest method by which the edge is highlighted to the pixels interpolated by the cubic method by which the values of tones are exactly reproduced. Sharp print result can be obtained, though the print quality is low.

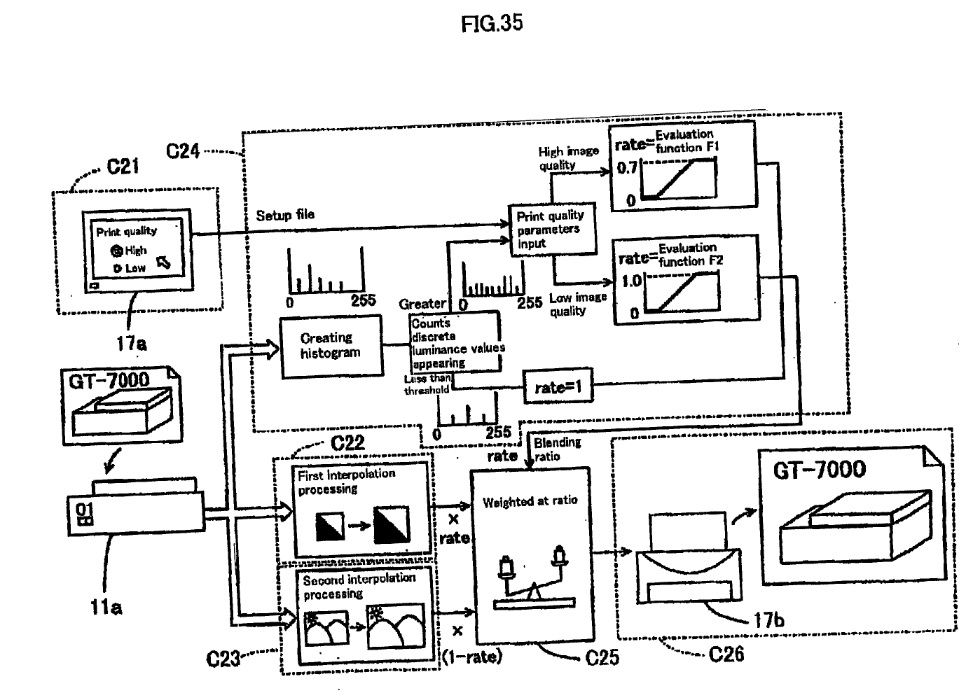

Finally, a general view of the present embodiment (second) of the invention is shown in FIG. 35.

The “Print Setup” window, when displayed, allows the user to set the print parameters that are varied, depending on the printer-specific capability. The settings of these parameters are stored into the setup file. If these parameters have previously been set, the setup file is referred to and read. If the operator changes the settings for print operation, the updated settings are read. The thus set print parameters are input in the step S303 that corresponds to the action of the print quality parameters acquisition unit C21.

On the other hand, in the step S304, source image data is scanned a histogram of the luminance values of the pixels in the zone comprising 5×5 pixels around tho target pixel is created. In the step S306, the number of discrete luminance values appearing in the created histogram is counted. If this count is less than a predetermined threshold, the attribute of the image is regarded as a simple non-natural picture and a blending ratio (rate) of interpolations by the first interpolation processing to those by the second interpolation processing is set to 1. If the count is greater than the threshold, the attribute of the image is regarded as a natural picture or a mixed image of natural and non-natural pictures and an evaluation function F is selected by which the rate should be determined. Selection of an evaluation function F depends on the print quality setting and there are two evaluation functions: evaluation function F1 for low image quality and evaluation function F2 for high image quality. The evaluation functions F are functions of the difference between the maximum luminance value Ymax and the minimum luminance value Ymin in the above zone and set the rate by evaluating edge-like visualization. For visualization that is more edge-like, the evaluation function F1 is applied and the percentage of such interpolation is set high that tends to highlight the edge and involves a relatively low load of arithmetic processing. For less edge-like visualization, the evaluation function F2 is applied and the percentage of such interpolation is set high that smoothes the edge and involves a high load of arithmetic processing. The unit to determine a blending ratio in this way, depending on whether print quality is high or low, is the second unit of determining a blending ratio C24.

In the step S314, interpolation processing is executed within the predetermined zone around the target pixel by the pattern matching method or the nearest method. The interpolation that tends to keep the edge intact is carried out by the first interpolation processing unit C22.

On the other hand, in the step S318, interpolation processing is executed by the cubic method in which subtle tone difference between the pixels is reflected, while the edge is made vague, as contrasted with the edge made by the pattern matching method. This interpolation is carried out by the second interpolation processing unit C23.

Then, in the step S320, the data of pixels separately interpolated by the first and second interpolations are weighted and added by the equation (1) to which the blending ratio (rate) determined as described above is assigned and blended pixels of first and second interpolations are generated. The total sum of the blending ratio, of course, becomes “1.” This step is carried out by the image data blending unit C25.

Following that, the above procedure is repeated with the target pixel being changed until all target pixels have been processed. Then, an interpolation-processed image is created. In the step S324, the completely interpolation-processed image data is supplied to the printer 17b where printing is executed. This step is carried out by the print control processing unit C26.

As explained above, in the present invention, the pixels interpolated by the first interpolation processing and the pixels interpolated by the second interpolation processing are blended, based on a predetermined evaluation function. The thus blended pixels show the characteristics that the edge is made vaguer than the edge made by the pattern matching method only, but sharper than the edge made by the cubic method only. These pixels are also characterized in that the fineness of subtle tone gradation decreases as contrasted with those interpolated by the cubic method only, whereas tone graduation is colorful as contrasted with those interpolated by the pattern matching method only. Because the above evaluation function is a unction of the width of the range within which the obtained luminance values fall, a ratio between the two modes of interpolation processing can be determined, according to the attribute of the source image. Furthermore, the blending ratio of the pixels interpolated by the interpolation processing taken to be more suitable for the print quality settings that directly influence the effect of interpolation processing to the pixels interpolated by the other interpolation processing is set high. In consequence, the merit of each mode of interpolation processing becomes more noticeable, whereas the demerit of each becomes mild. Thus, the present invention enables proper interpolation processing, according to the print quality settings, while preventing an error in selecting an interpolation method, based on the appraised attribute of the image for which interpolation is executed.

We claim:

1. A medium whereon an image data interpolation program has been recorded to implement pixel interpolation to image data of an image represented in multi-tone dot matrix pixels on a computer, said medium with the image data interpolation program recorded thereon, after being set ready for use on a computer, making the computer perform:
a function of image data acquisition that acquires said image data,
a first interpolation processing function that interpolates pixels to said image data without decreasing the degree of tone value difference between the existing pixels;
a second interpolation processing function that interpolates pixels to said image data without affecting the gradation of the tones of the image;
a first function of determining a blending ratio that appraises the attribute of the image, based on reference pixels around a pixel of target of interpolation and determines a blending ratio between pixel interpolations generated by said first interpolation processing and those generated by said second interpolation processing, based on the appraised attribute;
a function of image data blending that blends the image data of interpolations generated by said first interpolation processing function and the corresponding data generated by said second interpolation processing function at the determined blending ratio; and
an image data output function that outputs the thus blended data as interpolation-processed image data.

2. The medium with the image data interpolation program recorded thereon according to claim 1, wherein:
said first interpolation processing function is able to execute pattern matching interpolation which is performed, according to a predetermined rule, when a given pattern exists in the reference pixels, and nearest neighbor interpolation.

3. The medium with the image data interpolation program recorded thereon according to claim 1, wherein:
said first function of determining a blending ratio determines a blending ratio by means of an evaluation function that depends on the data of said reference pixels.

4. The medium with the image data interpolation program recorded thereon according to claim 1, wherein:
said first function of determining a blending ratio determines a blending ratio, based on the number of discrete tone values appearing in said reference pixels.

5. The medium with the image data interpolation program recorded thereon according to claim 4, wherein:
said first function of determining a blending ratio gives a blending ratio so that only said first interpolation processing will be active when the number of discrete tone values appearing in said reference pixels is less than a predetermined threshold.

6. The medium with the image data interpolation program recorded thereon according to claim 4, wherein:
said first function of determining a blending ratio increases the percentage of said first interpolation processing in direct proportion to the increase of the width of the range within which the tone values of said reference pixels fall when determining a blending ratio.

7. The medium with the image data interpolation program recorded thereon according to claim 4, wherein:
the tone values of said reference pixels are the luminance values of said reference pixels.

8. The medium with the image data interpolation program recorded thereon according to claim 1, wherein:
said medium, moreover, makes the computer perform:
a function of print quality parameters acquisition that acquires print quality parameters, according to which a printer prints an image from said image data;
a second function of determining a blending ratio that determines a blending ratio between the pixels interpolated by said first interpolation processing and those interpolated by said second interpolation processing, based on said print quality parameters acquired; and
a function of print control processing that executes print control processing, based on the data of pixel interpolations blended at said blending ratio.

9. The medium with the image data interpolation program recorded thereon according to claim 8, wherein:
said second function of determining a blending ratio determines a blending ratio by means of an evaluation function that depends on the print quality parameters acquired.

10. The medium with the image data interpolation program recorded thereon according to claim 8, wherein:
said second function of determining a blending ratio sets a higher percentage of said second interpolation processing when determining a blending ratio, when said print quality parameters acquired indicate higher print quality.

11. The medium with the image data interpolation program recorded thereon according to claim 8, wherein:
said second function of determining a blending ratio inhibits only said first interpolation processing from being active when said print quality parameters acquired indicate high print quality.

12. An image data interpolation method interpolating pixels to image data of an image represented in multi-tone dot matrix pixels comprising:
a step of image data acquisition that acquires said image data;
a first interpolation processing step that interpolates pixels to said image data without decreasing the degree of tone value difference between the existing pixels;
a second interpolation processing step that interpolates pixels to said image data without affecting the gradation of the tones of the image;
a first step of determining a blending ratio that appraises the attribute of the image, based on reference pixels around a pixel of target of interpolation and determines a blending ratio between pixel interpolations generated by said first interpolation processing and those generated by said second interpolation processing, based on the appraised attribute;
a step of image data blending that blends the image data of interpolations generated by said first interpolation processing step and the corresponding data generated by said second interpolation processing step at the determined blending ratio; and
an image data output step that outputs the thus blended data as interpolation-processed image data.

13. The image data interpolation method according to claim 12, wherein:
said first interpolation processing step is able to execute pattern matching interpolation which is performed, according to a predetermined rule, when a given pattern exists in the reference pixels, and nearest neighbor interpolation.

14. The image data interpolation method according to claim 12, wherein:
said first step of determining a blending ratio determines a blending ratio by means of an evaluation function that depends on the data of said reference pixels.

15. The image data interpolation method according to claim 12, wherein:
said first step of determining a blending ratio determines a blending ratio, based on the number of discrete tone values appearing in said reference pixels.

16. The image data interpolation method according to claim 15, wherein:
said first step of determining a blending ratio gives a blending ratio so that only said first interpolation processing will be active when the number of discrete tone values appearing in said reference pixels is less than a predetermined threshold.

17. The image data interpolation method according to claim 15, wherein:
said first step of determining a blending ratio increases the percentage of said first interpolation processing in direct proportion to the increase of the width of the range within which the tone values of said reference pixels fall when determining a blending ratio.

18. The image data interpolation method according to claim 15, wherein:
the tone values of said reference pixels are the luminance values of said reference pixels.

19. The image data interpolation method according to claim 12, further comprising:
a step of print quality parameters acquisition that acquires print quality parameters, according to which a printer prints an image from said image data;
a second step of determining a blending ratio that determines a blending ratio between the pixels interpolated by said first interpolation processing and those interpolated by said second interpolation processing, based on said print quality parameters acquired; and
a step of print control processing that executes print control processing, based on the data of pixel interpolations blended at said blending ratio.

20. The image data interpolation method according to claim 19, wherein:
said second step of determining a blending ratio determines a blending ratio by means of an evaluation function that depends on the print quality parameters acquired.

21. The image data interpolation method according to claim 19, wherein:
said second step of determining a blending ratio sets a higher percentage of said second interpolation processing when determining a blending ratio, when said print quality parameters acquired indicate higher print quality.

22. The image data interpolation method according to claim 19, wherein:
said second step of determining a blending ratio inhibits only said first interpolation processing from being active when said print quality parameters acquired indicate high print quality.

23. An image data interpolation apparatus for interpolating pixels to image data of an image represented in multi-tone dot matrix pixels comprising:
an image data acquisition unit that acquires said image data;
a first interpolation processing unit that interpolates pixels to said image data without decreasing the degree of tone value difference between the existing pixels;
a second interpolation processing unit that interpolates pixels to said image data without affecting the gradation of the tones of the image;
a first unit of determining a blending ratio that appraises the attribute of the image, based on reference pixels around a pixel of target of interpolation and determines a blending ratio between pixel interpolations generated by said first interpolation processing and those generated by said second interpolation processing, based on the appraised attribute;
an image data blending unit that blends the image data of interpolations generated by said first interpolation processing step and the corresponding data generated by said second interpolation processing step at the determined blending ratio; and
an image data output unit that outputs the thus blended data as interpolation-processed image data.

24. The image data interpolation apparatus according to claim 23, wherein:
said first interpolation processing unit is able to execute pattern matching interpolation which is performed, according to a predetermined rule, when a given pattern exists in the reference pixels, and nearest neighbor interpolation.

25. The image data interpolation apparatus according to claim 23, wherein:
said first unit of determining a blending ratio determines a blending ratio by means of an evaluation function that depends on the data of said reference pixels.

26. The image data interpolation apparatus according to claim 23, wherein:
said first unit of determining a blending ratio determines a blending ratio, based on the number of discrete tone values appearing in said reference pixels.

27. The image data interpolation apparatus according to claim 26, wherein:
said first unit of determining a blending ratio gives a blending ratio so that only said first interpolation processing will be active when the number of discrete tone values appearing in said reference pixels is less than a predetermined threshold.

28. The image data interpolation apparatus according to claim 26, wherein:
said first unit of determining a blending ratio increases the percentage of said first interpolation processing in direct proportion to the increase of the width of the range within which the tone values of said reference pixels fall when determining a blending ratio.

29. The image data interpolation apparatus according to claim 26, wherein:
the tone values of said reference pixels are the luminance values of said reference pixels.

30. The image data interpolation apparatus according to claim 23, further comprising:
a print quality parameters acquisition unit that acquires print quality parameters, according to which a printer prints an image from said image data;
a second unit of determining a blending ratio that determines a blending ratio between the pixels interpolated by said first interpolation processing and those interpolated by said second interpolation processing, based on said print quality parameters acquired; and
a print control processing unit that executes print control processing, based on the data of pixel interpolations blended at said blending ratio.

31. The image data interpolation apparatus according to claim 30, wherein:
said second unit of determining a blending ratio determines a blending ratio by means of an evaluation function that depends on the print quality parameters acquired.

32. The image data interpolation apparatus according to claim 30, wherein:
said second unit of determining a blending ratio sets a higher percentage of said second interpolation processing when determining a blending ratio, when said print quality parameters acquired indicate higher print quality.

33. The image data interpolation apparatus according to claim 30, wherein:
said second unit of determining a blending ratio inhibits only said first interpolation processing from being active when said print quality parameters acquired indicate high print quality.
